(19) United States
(12) Patent Application Publication
(10) Pub. No.: US 2025/0240458 A1
(43) Pub. Date: Jul. 24, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Junru LI, Beijing (CN); Ye-Kui Wang, Los Angeles, CA (US); Kai Zhang, Los Angeles, CA (US); Li Zhang, Los Angeles, CA (US); Yue Li, Los Angeles, CA (US); Chaoyi Lin, Beijing (CN)

(21) Appl. No.: 19/178,593

(22) Filed: Apr. 14, 2025

Related U.S. Application Data
(63) Continuation of application No. PCT/CN2023/124615, filed on Oct. 13, 2023.

(30) Foreign Application Priority Data
Oct. 14, 2022 (WO) PCT/CN2022/125473

(51) Int. Cl. H04N 19/80; H04N 19/117; H04N 19/172; H04N 19/70; H04N 19/85

(52) U.S. Cl. CPC H04N 19/80; H04N 19/117; H04N 19/172; H04N 19/70; H04N 19/85

(57) ABSTRACT

Embodiments of the present disclosure provide a solution for video processing. A method for video processing is proposed. The method comprises: performing a conversion between a current video unit of a video and a bitstream of the video, wherein the bitstream comprises at least one set of syntax elements for activating at least one neural-network post-filter (NNPF) for the current video unit, and the current video unit is a portion of a current picture of the video.

### CROSS REFERENCE TO RELATED APPLICATIONS

This application is a continuation of International Application No. PCT/CN2023/124615, filed on Oct. 13, 2023, which claims the benefit of International Application No. PCT/CN2022/125473, filed on Oct. 14, 2022. The entire contents of these applications are hereby incorporated by reference in their entireties.

### FIELDS

Embodiments of the present disclosure relates generally to video processing techniques, and more particularly, to extension of neural-network post-filter activation and neural-network post-filter characteristics.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding quality of video coding techniques is generally expected to be further improved.

### SUMMARY

Embodiments of the present disclosure provide a solution for video processing.

In a first aspect, a method for video processing is proposed. The method comprises: performing a conversion between a current video unit of a video and a bitstream of the video, wherein the bitstream comprises at least one set of syntax elements for activating at least one neural-network post-filter (NNPF) for the current video unit, and the current video unit is a portion of a current picture of the video.

According to the method in accordance with the first aspect of the present disclosure, the activation of one or more NNPFs for a portion of a picture of the video may be controlled with the at least one set of syntax elements. In other words, the activation of one or more NNPFs may be controlled at a level lower than the picture level, such as a slice level, a tile level or the like. Compared with the conventional solution, where the activation of one or more NNPFs is controlled at the picture level, the proposed method can advantageously enable the application of NNPF in a refined manner, and thus the coding quality can be improved.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: performing a conversion between a current video unit of the video and the bitstream, wherein the bitstream comprises at least one set of syntax elements for activating at least one neural-network post-filter (NNPF) for the current video unit, and the current video unit is a portion of a current picture of the video.

In a fifth aspect, a method for storing a bitstream of a video is proposed. The method comprises: performing a conversion between a current video unit of the video and the bitstream, wherein the bitstream comprises at least one set of syntax elements for activating at least one neural-network post-filter (NNPF) for the current video unit, and the current video unit is a portion of a current picture of the video; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example of raster-scan slice partitioning of a picture;

FIG. 5 illustrates an example of rectangular slice partitioning of a picture;

FIG. 6 illustrates an example of a picture partitioned into tiles and rectangular slices;

FIG. 7 illustrates an example of subpicture partitioning of a picture;

FIG. 8A illustrates an example of CTBs crossing picture borders;

FIG. 8B illustrates a further example of CTBs crossing picture borders;

FIG. 8C illustrates a still further example of CTBs crossing picture borders;

FIG. 9 illustrates an illustration of luma data channels;

FIG. 10 illustrates a flowchart of a method for video processing in accordance with embodiments of the present disclosure; and

FIG. 11 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

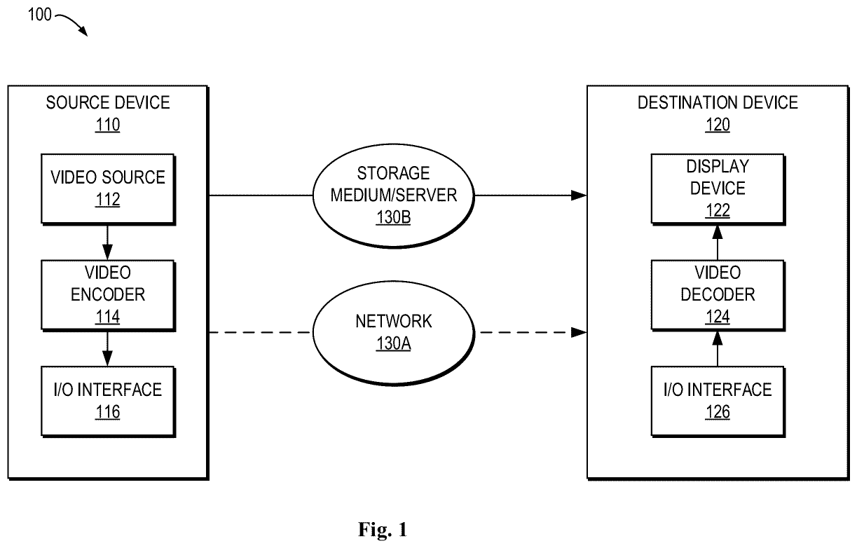

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

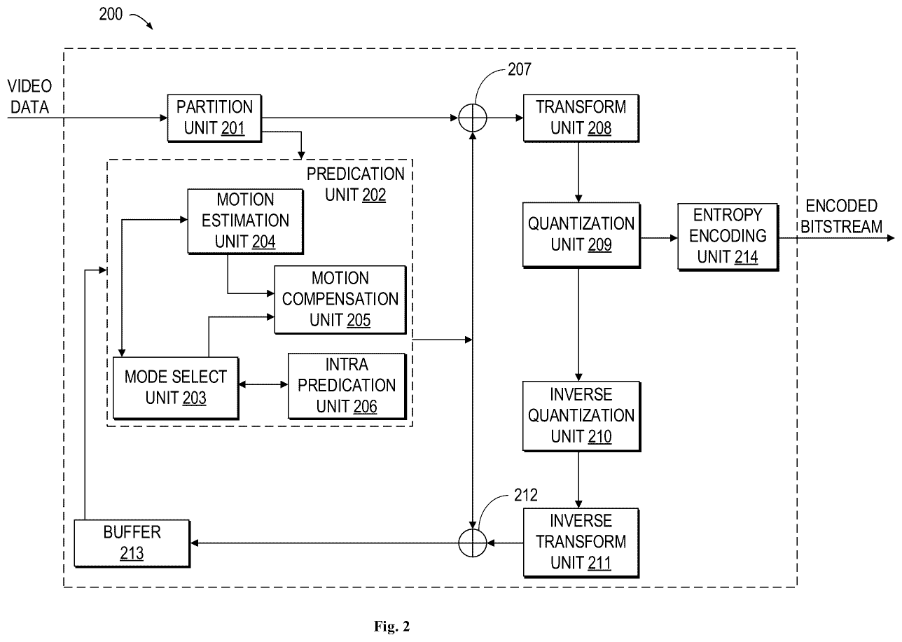

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

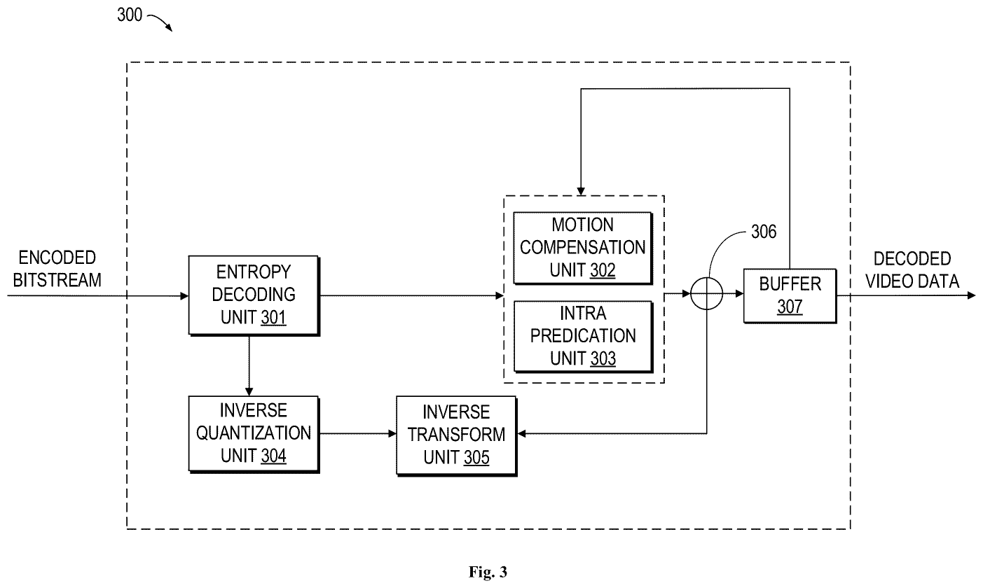

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure.

In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block.

The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to image/video coding technologies. Specifically, it is related to usage and controlling for neural network post processing filters signaled in a video bitstream. Herein usage and controlling can be applied in a video unit (e.g., picture/slice/CTU). The ideas may be applied individually or in various combinations, for video bitstreams coded by any codec, e.g., the versatile video coding (VVC) standard and/or the versatile SEI messages for coded video bitstreams (VSEI) standard.

### 2. Abbreviations

APS Adaptation Parameter Set
AU Access Unit
CLVS Coded Layer Video Sequence
CLVSS Coded Layer Video Sequence Start
CRC Cyclic Redundancy Check
CVS Coded Video Sequence
FIR Finite Impulse Response
IRAP Intra Random Access Point
NAL Network Abstraction Layer
PPS Picture Parameter Set
PU Picture Unit
RASL Random Access Skipped Leading
SEI Supplemental Enhancement Information
STSA Step-wise Temporal Sublayer Access
VCL Video Coding Layer
VSEI versatile supplemental enhancement information (Rec. ITU-T H.274 ISO/IEC 23002-7)
VUI Video Usability Information
VVC versatile video coding (Rec. ITU-T H.266|ISO/IEC 23090-3)

### 3. Introduction

### 3.1. Video Coding Standards

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. Since then, many new methods have been adopted by JVET and put into the reference software named Joint Exploration Model (JEM). The JVET was later renamed to be the Joint Video Experts Team (JVET) when the Versatile Video Coding (VVC) project officially started. VVC is the new coding standard, targeting at 50% bitrate reduction as compared to HEVC, that has been finalized by the JVET at its 19th meeting ended at Jul. 1, 2020.

The Versatile Video Coding (VVC) standard (ITU-T H.266|ISO/IEC 23090-3) and the associated Versatile Supplemental Enhancement Information for coded video bitstreams (VSEI) standard (ITU-T H.274|ISO/EC 23002-7) have been designed for use in a maximally broad range of applications, including both the traditional uses such as television broadcast, video conferencing, or playback from storage media, and also newer and more advanced use cases such as adaptive bit rate streaming, video region extraction, composition and merging of content from multiple coded video bitstreams, multiview video, scalable layered coding, and viewport-adaptive 3600 immersive media.

The Essential Video Coding (EVC) standard (ISO/IEC 23094-1) is another video coding standard that has recently been developed by MPEG.

### 3.2. Definitions of Video Units

A picture is divided into one or more tile rows and one or more tile columns. A tile is a sequence of CTUs that covers a rectangular region of a picture. The CTUs in a tile are scanned in raster scan order within that tile.

A slice consists of an integer number of complete tiles or an integer number of consecutive complete CTU rows within a tile of a picture. Consequently, each vertical slice boundary is always also a vertical tile boundary. It is possible that a horizontal boundary of a slice is not a tile boundary but consists of horizontal CTU boundaries within a tile; this occurs when a tile is split into multiple rectangular slices, each of which consists of an integer number of consecutive complete CTU rows within the tile.

Two modes of slices are supported, namely the raster-scan slice mode and the rectangular slice mode. In the raster-scan slice mode, a slice contains a sequence of complete tiles in a tile raster scan of a picture. In the rectangular slice mode, a slice contains either a number of complete tiles that collectively form a rectangular region of the picture or a number of consecutive complete CTU rows of one tile that collectively form a rectangular region of the picture. Tiles within a rectangular slice are scanned in tile raster scan order within the rectangular region corresponding to that slice.

A subpicture contains one or more slices that collectively cover a rectangular region of a picture. Consequently, each subpicture boundary is also always a slice boundary, and each vertical subpicture boundary is always also a vertical tile boundary.

One or both of the following conditions shall be fulfilled for each subpicture and tile:
All CTUs in a subpicture belong to the same tile.
All CTUs in a tile belong to the same subpicture.

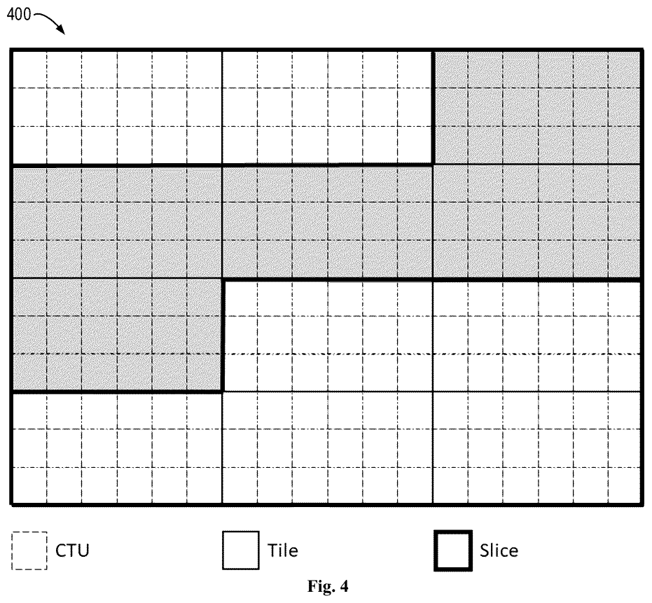

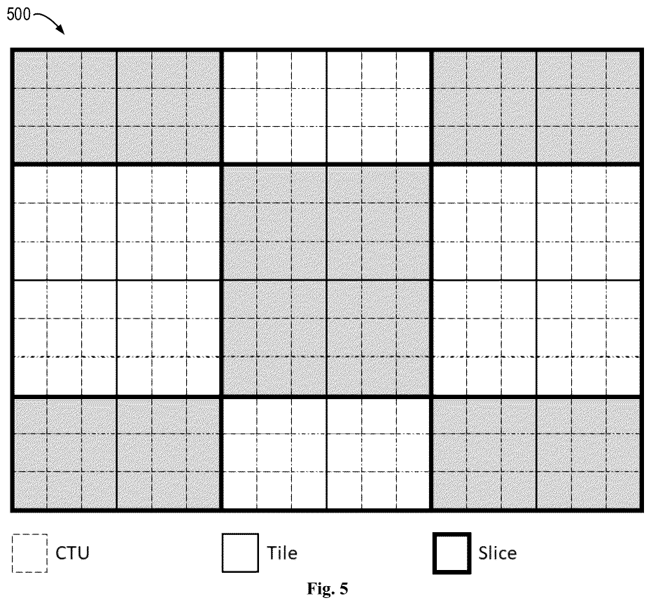

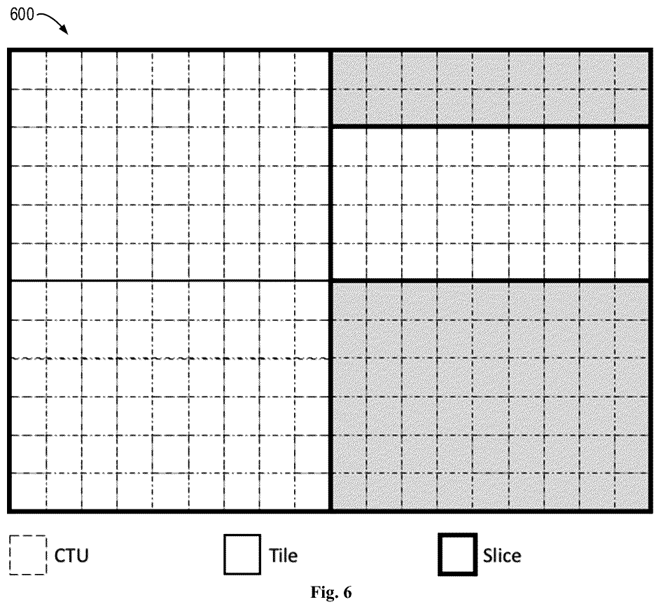

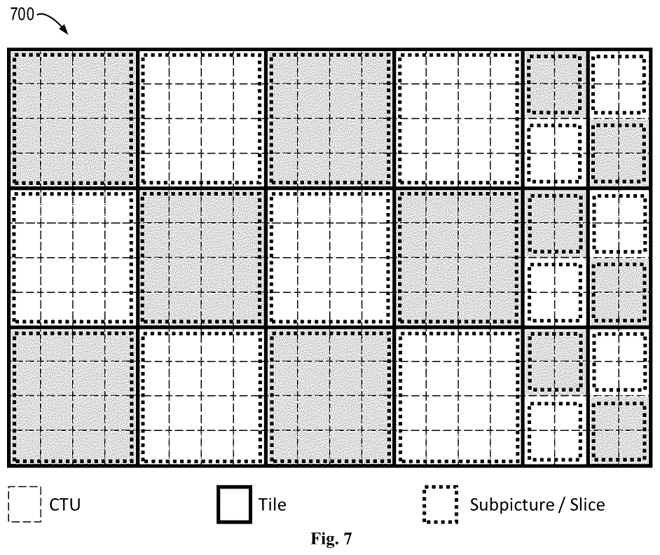

FIG. 4 shows an example of raster-scan slice partitioning of a picture, where the picture is divided into 12 tiles and 3 raster-scan slices. More specifically, a picture with 18 by 12 luma CTUs is partitioned into 12 tiles and 3 raster-scan slices. FIG. 5 shows an example of rectangular slice partitioning of a picture, where the picture is divided into 24 tiles (6 tile columns and 4 tile rows) and 9 rectangular slices. More specifically, a picture with 18 by 12 luma CTUs is partitioned into 24 tiles and 9 rectangular slices. FIG. 6 shows an example of a picture partitioned into tiles and rectangular slices, where the picture is divided into 4 tiles (2 tile columns and 2 tile rows) and 4 rectangular slices. FIG. 7 shows an example of subpicture partitioning of a picture, where a picture is partitioned into 18 tiles, 12 tiles on the left-hand side each covering one slice of 4 by 4 CTUs and 6 tiles on the right-hand side each covering 2 vertically-stacked slices of 2 by 2 CTUs, altogether resulting in 24 slices and 24 subpictures of varying dimensions (each slice is a subpicture).

### 3.2.1. CTU/CTB Sizes

In VVC, the CTU size, signaled in SPS by the syntax element log 2_ctu_size_minus2, could be as small as 4×4.

7.3.2.3 Sequence parameter set RBSP syntax

| | Descriptor |
|---|---|
| seq_parameter_set_rbsp( ) { | |
| sps_decoding_parameter_set_id | u(4) |
| sps_video_parameter_set_id | u(4) |
| sps_max_sub_layers_minus1 | u(3) |
| sps_reserved_zero_5bits | u(5) |
| profile_tier_level( sps_max_sub_layers_minus1 ) | |
| gra_enabled_flag | u(1) |
| sps_seq_parameter_set_id | ue(v) |
| chroma_format_idc | ue(v) |
| if( chroma_format_idc = = 3 ) | |
| separate_colour_plane_flag | u(1) |
| pic_width_in_luma_samples | ue(v) |
| pic_height_in_luma_samples | ue(v) |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| bit_depth_luma_minus8 | ue(v) |
| bit_depth_chroma_minus8 | ue(v) |
| log2_max_pic_order_cnt_lsb_minus4 | ue(v) |
| sps_sub_layer_ordering_info_present_flag | u(1) |
| for( i = ( sps_sub_layer_ordering_info_present_flag ? 0 : | |
| sps_max_sub_layers_minus1 ); | |
| i <= sps_max_sub_layers_minus1; i++ ) { | |
| sps_max_dec_pic_buffering_minus1[ i ] | ue(v) |
| sps_max_num_reorder_pics[ i ] | ue(v) |
| sps_max_latency_increase_plus1[ i ] | ue(v) |
| } | |
| long_term_ref_pics_flag | u(1) |
| sps_idr_rpl_present_flag | u(1) |
| rpl1_same_as_rpl0_flag | u(1) |
| for( i = 0; i < ! rpl1_same_as_rpl0_flag ? 2 : 1; i++ ) { | |
| num_ref_pic_lists_in_sps[ i ] | ue(v) |
| for( j = 0; j < num_ref_pic_lists_in_sps[ i ]; j++) | |
| ref_pic_list_struct( i, j ) | |
| } | |
| qtbtt_dual_tree_intra_flag | u(1) |
| log2_ctu_size_minus2 | ue(v) |
| log2_min_luma_coding_block_size_minus2 | ue(v) |
| partition_constraints_override_enabled_flag | u(1) |
| sps_log2_diff_min_qt_min_cb_intra_slice_luma | ue(v) |
| sps_log2_diff_min_qt_min_cb_inter_slice | ue(v) |
| sps_max_mtt_hierarchy_depth_inter_slice | ue(v) |
| sps_max_mtt_hierarchy_depth_intra_slice_luma | ue(v) |
| if( sps_max_mtt_hierarchy_depth_intra_slice_luma != 0 ) { | |
| sps_log2_diff_max_bt_min_qt_intra_slice_luma | ue(v) |
| sps_log2_diff_max_tt_min_qt_intra_slice_luma | ue(v) |
| } | |
| if( sps_max_mtt_hierarchy_depth_inter_slices != 0 ) { | |
| sps_log2_diff_max_bt_min_qt_inter_slice | ue(v) |
| sps_log2_diff_max_tt_min_qt_inter_slice | ue(v) |
| } | |
| if( qtbtt_dual_tree_intra_flag ) { | |
| sps_log2_diff_min_qt_min_cb_intra_slice_chroma | ue(v) |
| sps_max_mtt_hierarchy_depth_intra_slice_chroma | ue(v) |
| if ( sps_max_mtt_hierarchy_depth_intra_slice_chroma != 0 ) { | |
| sps_log2_diff_max_bt_min_qt_intra_slice_chroma | ue(v) |
| sps_log2_diff_max_tt_min_qt_intra_slice_chroma | ue(v) |
| } | |
| } | |
| ... | |
| rbsp_trailing_bits( ) | |
| } | |

log2_ctu_size_minus2 plus 2 specifies the luma coding tree block size of each CTU.
log2_min_luma_coding_block_size_minus2 plus 2 specifies the minimum luma coding block size.
The variables CtbLog2SizeY, CtbSizeY, MinCbLog2SizeY, MinCbSizeY, MinTbLog2SizeY,
MaxTbLog2SizeY, MinTbSizeY, MaxTbSizeY, PicWidthInCtbsY, PicHeightInCtbsY, PicSizeInCtbsY,
PicWidthInMinCbsY, PicHeightInMinCbsY, PicSizeInMinCbsY, PicSizeInSamplesY,
PicWidthInSamplesC and PicHeightInSamplesC are derived as follows.

| | |
|---|---|
| CtbLog2SizeY = log2_ctu_size_minus2 + 2 | (7-9) |
| CtbSizeY = 1 << CtbLog2SizeY | (7-10) |
| MinCbLog2SizeY = log2_min_luma_coding_block_size_minus2 + 2 | (7-11) |

| | |
|---|---|
| MinCbSizeY = 1 << MinCbLog2SizeY | (7-12) |
| MinTbLog2SizeY = 2 | (7-13) |

| | |
|---|---|
| MaxTbLog2SizeY = 6 | (7-14) |
| MinTbSizeY = 1 << MinTbLog2SizeY | (7-15) |
| MaxTbSizeY = 1 << MaxTbLog2SizeY | (7-16) |
| PicWidthInCtbsY = Ceil( pic_width_in_luma_samples ÷ CtbSizeY ) | (7-17) |
| PicHeightInCtbsY = Ceil( pic_height_in_luma_samples ÷ CtbSizeY ) | (7-18) |
| PicSizeInCtbsY = PicWidthInCtbsY * PicHeightInCtbsY | (7-19) |
| PicWidthInMinCbsY = pic_width_in_luma_samples / MinCbSizeY | (7-20) |
| PicHeightInMinCbsY = pic_height_in_luma_samples / MinCbSizeY | (7-21) |
| PicSizeInMinCbsY = PicWidthInMinCbsY * PicHeightInMinCbsY | (7-22) |
| PicSizeInSamplesY = pic_width_in_luma_samples * pic_height_in_luma_samples | (7-23) |
| PicWidthInSamplesC = pic_width_in_luma_samples / Sub WidthC | (7-24) |
| PicHeightInSamplesC = pic_height_in_luma_samples / SubHeightC | (7-25) |

### 3.2.2. CTUs in a Picture

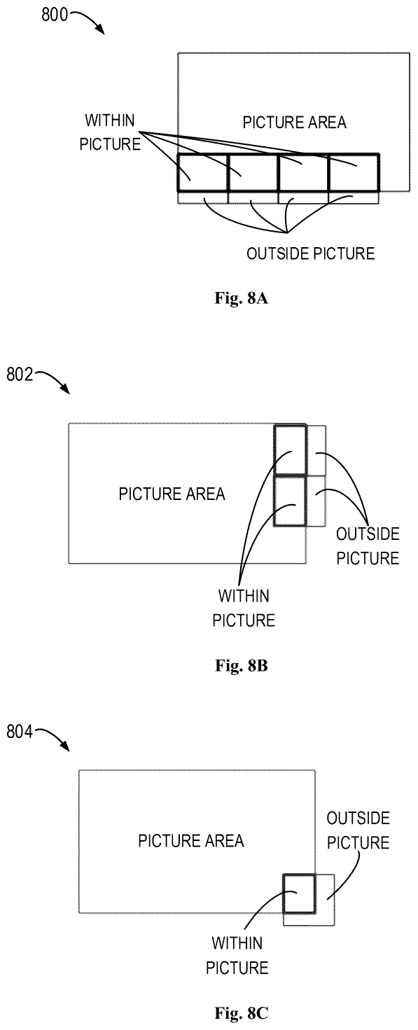

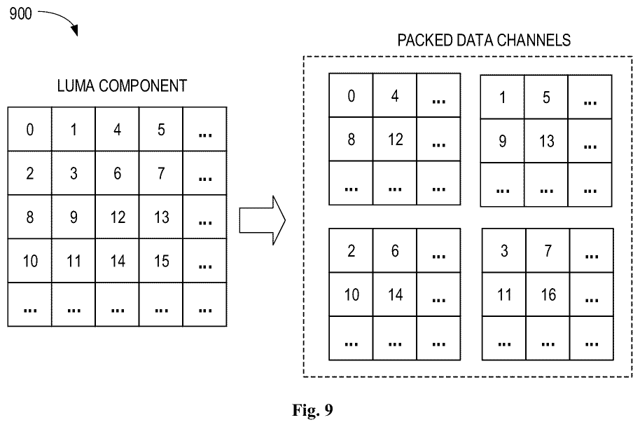

Suppose the CTB/LCU size indicated by M×N (typically M is equal to N, as defined in HEVC/VVC), and for a CTB located at picture (or tile or slice or other kinds of types, picture border is taken as an example) border, K×L samples are within picture border wherein either K<M or L<N. For those CTBs as depicted in FIGS. 8A-8C, the CTB size is still equal to M×N, however, the bottom boundary/right boundary of the CTB is outside the picture. FIG. 8A is a diagram 800 illustrating an example of CTBs crossing picture borders, where K=M, L<N, and CTBs cross the bottom picture border. FIG. 8B is a diagram 802 illustrating a further example of CTBs crossing picture borders, where K<M, L=N, and CTBs cross the right picture border. FIG. 8C is a diagram 804 illustrating a still further example of CTBs crossing picture borders, where K<M, L<N and CTBs cross the right bottom picture border.

### 3.3. SEI Messages in General and in VVC and VSEI

SEI messages assist in processes related to decoding, display or other purposes. However, SEI messages are not required for constructing the luma or chroma samples by the decoding process. Conforming decoders are not required to process this information for output order conformance. Some SEI messages are required for checking bitstream conformance and for output timing decoder conformance. Other SEI messages are not required for check bitstream conformance.

Annex D of VVC specifies syntax and semantics for SEI message payloads for some SEI messages, and specifies the use of the SEI messages and VUI parameters for which the syntax and semantics are specified in ITU-T H.274 ISO/IEC 23002-7.

### 3.4. Signalling of Neural-Network Post-Filters

An existing design includes the specification of two SEI messages for signalling of neural-network post-filters, as follows.

### 4. Problems

There are some problems in the current design of neural-network post-filter activation (NNPFA) and neural-network post-filter characteristics (NNPFC) SEI message.
1) The NNPFA and/or NNPFC SEI message persists only for the current picture. However, the neural-network post-processing filter (NNPF) may be effective only for part region of the current picture, such as slice, coding tree unit, coding unit, coding block, region of interest. And NNPF may be also effective for whole sequence such that it is efficient to only signal one NNPFA and/or NNPFC message instead of signal NNPFA and/or NNPFC message for every picture. Therefore, it is necessary to supplement certain region information into NNPFA and/or NNPFC.
2) There may be several NNPFA and/or NNPFC SEI messages present for the same picture. And only one post-processing filter specified by nnpfa_id is activated in one SEI message. However, various content in video unit (such as picture, slice, coding unit, etc.) may require different post-processing filters. Multiple set of filters may be useful for different content such that multiple groups of syntax elements for multiple sets of filters should be added into one NNPFA and/or NNPFC SEI message and how to use/switch the post-processing filters for video units need to be supplemented in NNPFA and/or NNPFC SEI message.
3) The neural-network post-processing filter could improve the performance of visual quality. Generally speaking, NNPF with higher complexity may produce better performance improvement. In current design, SEI message only provides the complexity characteristic. But the performance characteristic is ignored.

### 5. Detailed Solutions

To solve the above problems, methods as summarized below are disclosed. The solutions should be considered as examples to explain the general concepts and should not be interpreted in a narrow way. Furthermore, these solutions can be applied individually or combined in any manner.
1) It is proposed that the activation and/or enabling and/or presence and/or usage of neural-network post-filter (NNPF) for video units may be controlled by one or multiple groups of syntax elements in a video message unit.
   a. In one example, the video message unit may be a SEI message, such as NNPFA SEI message.
   b. In one example, the group of syntax elements may be expressed as SE_activation.
      i. In one example, SE_activation may comprise multiple syntax elements.
         1. In one example, one or multiple nnpfa_id may be involved in SE_activation.
         a. In one example, multiple filters may be indicated by nnpfa_id[i].
         i. In one example, i is the index of filters.
         2. In one example, the number of NNPF may be involved in SE_activation.
         a. In one example, the number of NNPF may be indicated by nnpfa_num_minus1.
         3. In one example, purpose of range information of color components may be involved in SE_activation.
         4. In one example, the range of color components may be involved in SE_activation.
   c. A video unit may be whole or part or sub-region of a video/sequence/image in the following bullets.
      i. In one example, video unit may be a sequence.
      ii. In one example, video unit may be a picture.
      iii. In one example, video unit may be a slice.
      iv. In one example, video unit may be a tile/brick.
      v. In one example, video unit may be a subpicture.
      vi. In one example, video unit may be one or multiple CTUs/CTBs.
      vii. In one example, video unit may be a CTU/CTB row.
      viii. In one example, video unit may be one or multiple CUs/CBs.
      ix. In one example, video unit may be one or multiple VPDU (Virtual Pipeline Data Unit).
      x. In one example, video unit may be a sub-region within a picture/slice/tile/brick.
   d. A video unit may be one or multiple patches of picture in the following bullets.
      i. In one example, patch is a rectangular array of samples from a component of a picture
         1. In one example, component may be a luma or chroma component.
         2. In one example, component may be a Y or U(Cb) or V(Cr) component.
         3. In one example, component may be a R or G or B component.
      ii. In one example, patch may be defined in the video message.
         1. In one example, patch size may be acquired from NNPFC SEI message.
         a. In one example, the patch width may be nnpfc_patch_width_minus1+1.
         b. In one example, the patch height may be multiple of (nnpfc_patch_width_minus1+1).
         c. In one example, the patch width may be nnpfc_patch_height_minus1+1.
         d. In one example, the patch height may be multiple of (nnpfc_patch_height_minus1+1).
   e. A video unit may be one or multiple regions of interest (ROI) in the following bullets.
      i. In one example, one ROI may include one or multiple initial point.
         1. In one example, initial point may include horizontal coordinate (x₀).
         2. In one example, initial point may include vertical coordinate (y₀).
      ii. In one example, one ROI may include one or multiple ending point.
         1. In one example, ending point may include horizontal coordinate (xₙ).
         2. In one example, ending point may include vertical coordinate (yₙ).
      iii. In one example, one ROI may include one or multiple size information.
         1. In one example, one ROI may include horizontal samples (width) of region.
         2. In one example, one ROI may include vertical samples (height) of region.
      iv. In one example, one ROI may be specified or decided according to the output of applying image/video segmentation algorithms on the decoded output picture.
         1. In one example, all foreground regions are considered as ROI.
         2. In one example, all background regions are considered as ROI.
         3. In one example, regions corresponding to certain types of content (e.g. car, people, cat, sky, etc.) are considered as ROI.
      v. In one example, one ROI may be specified or decided according to the output of applying image/video object classification/detection algorithms on the decoded output picture.
         1. In one example, regions corresponding to certain/all classes of detected objects are considered as ROI.
         2. In one example, regions not containing any detected objects are considered as ROI.
   f. In one example, whether one or multiple groups of syntax elements should be applied to a video unit (such as a picture or a slice) may depend on the relative relationship when signaling the video unit and the video message unit.
      i. In one example, one or multiple groups of syntax elements should be applied to a video unit signaled after the video message unit.
      ii. In one example, one or multiple groups of syntax elements should be applied to a video unit signaled before the video message unit.
2) The group of syntax elements (expressed as SE_activation) indicating the activation and/or enabling and/or presence and/or usage may depend on color components and/or color formats.
   a. In one example, syntax elements (expressed as SE_color_purpose) indicating the purpose of range information of color components may be added into NNPFA SEI message.
      i. In one example, one (1^{st}) purpose may be that only one group of SE_activation need to be involved in NNPFA SEI message and the activation and/or enabling and/or presence and/or usage controlled by SE_activation are commonly used for available color components specified in NNPFC SEI message.
         1. In one example, the NNPFC SEI message may define the available color components for a post-processing filter identified by syntax element nnpfc_id or it is limited that the filter can be only used for specific color components which are determined by the design of the post filer.
         2. In one example, the value of one syntax element of SE_color_purpose equal to 0 specifies 1^{st} purpose.
      ii. In one example, one (2^{nd}) purpose may be that only one group of SE_activation need to be involved in NNPFA SEI message and the activation and/or enabling and/or presence and/or usage controlled by SE_activation are commonly used for all color components in specified color range (SE_color_range in the following discussion).
         1. In one example, the value of one syntax element of SE_color_purpose equal to 1 specifies 2^{nd} purpose.
      iii. In one example, one (3^{rd}) purpose may be that multiple groups of SE_activation need to be involved in NNPFA SEI message and need to be used for different color components in specified color range (SE_color_range in the following discussion).
         1. In one example, the value of one syntax element of SE_color_purpose equal to 2 specifies 3^{rd} purpose.
      iv. In one example, the syntax elements SE_color_purpose may be not signaled.
         1. In one example, one purpose (in above discussion or not) may be set as default purpose.
   b. In one example, syntax elements (expressed as SE_color_range) indicating the range of color components may be added into NNPFA SEI message. SE_activation may be used for all color components in specified color range indicated by SE_color_range.
      i. In one example, the usage of SE_color_range may be depended on the SE_color_purpose.
         1. In one example, when the value of one syntax element of SE_color_purpose equals to 1 or 2 (be equivalent to the 2^{nd} purpose or 3^{rd} purpose in the above discussion) the SE_color_range may be signaled.
         2. In one example, when the value of one syntax element of SE_color_purpose equals to 0 (be equivalent to the 1^{st} purpose in the above discussion) the SE_color_range may be not signaled.
      ii. In one example, SE_activation may be used for color components in specified color range indicated by SE_color_range.
         1. In one example, one group of SE_activation need to be involved in NNPFA SEI message and is commonly used for all available color components.
         2. In one example, multiple groups of SE_activation need to be involved in NNPFA SEI message and are used for different available color components.
         a. In one example, the number of groups of SE_activation may equal to the number of available color components.
      iii. In one example, color range may include Y and/or U(Cb) and/or V(Cr) component.
      iv. In one example, color range may include R and/or G and/or B component.
      v. In one example, the max number of color components in color range may be 3, 2, 1.
   c. In one example, the syntax elements (expressed as SE_activation) may be unified for more than one color components.
      i. In one example, the syntax elements may indicate the activation and/or enabling and/or presence and/or usage of all color component.
         1. In one example, color components include Y and/or Cb and/or Cr components.
         2. In one example, color components include R and/or G and/or B components.
      ii. In one example, the syntax elements may indicate the activation and/or enabling and/or presence and/or usage of chroma components
         1. In one example, color components include Cb and Cr components.
   d. In one example, the syntax elements (expressed as SE_activation) may be separate for color components.
      i. In one example, the syntax elements may be different for all color components
         1. In one example, first group of syntax elements may be used for first color component.
         a. In one example, first color component may be Y and/or Cb and/or Cr components.
         b. In one example, first color component may be R and/or G and/or B components.
         2. In one example, second group of syntax elements may be used for second color component.
         a. In one example, second color component may be Cb and/or Y and/or Cr components.
         b. In one example, second color component may be G and/or R and/or B components.
         3. In one example, third group of syntax elements may be used for third color component.
         a. In one example, third color component may be Cr and/or Y and/or Cb components.
         b. In one example, third color component may be B and/or G and/or R components.
      ii. In one example, the syntax elements (expressed as SE_activation) may be different for luma and chroma color components
         1. In one example, first group of syntax elements may be used for luma component.
         2. In one example, second group of syntax elements may be used for chroma component.
         a. In one example, second group of syntax elements may be same for Cb and Cr components.
3) How to/whether to signal the group of syntax elements (expressed as SE_activation) indicating the activation and/or enabling and/or presence and/or usage may depend on the number of NNPF.
   a. In one example, one or more syntax elements indicating the number of NNPF may be added into NNPFA SEI message.
      i. In one example, the syntax element may be expressed as nnpfa_num_minus1.
         1. In one example, the number of NNPF may be equal to nnpfa_num_minus1+1.
         2. In one example, the value of nnpfa_num_minus1 shall be in the range of 0 to 2^{k}-1, inclusive.
         a. In one example, k may be integer, such as 0, 1, 2, 3, 4, 5, 6, 7, . . . , 32.
         3. In one example, the value of nnpfa_num_minus1 shall be in the range of 0 to 255, inclusive.
         4. In one example, when nnpfa_num_minus1 is not present, the value of nnpfa_num_minus1 is inferred to be equal to 0.
         5. In one example, nnpfa_num_minus1 may be dependent on the region type of NNPF.
         a. In one example, region type of NNPF may be indicated by nnpfa_region_type.
         b. In one example, nnpfa_num_minus1 may be NOT signaled when nnpfa_region_type is equal to specific value.
         c. In one example, nnpfa_num_minus1 may be NOT signaled when nnpfa_region_type is equal to 0.
      ii. In one example, the number of NNPF may be ue(v)-coded.
   b. In one example, the number of NNPF may be smaller than the max value of nnpfc_id plus one.
   c. In one example, the number of NNPF may be not signaled into NNPFA SEI message.
      i. In one example, the number of NNPF may be set as default value.
      ii. In one example, the number of NNPF may be 1.
4) One or more syntax elements indicating the identification of NNPF may be added into NNPFA SEI message.
   a. In one example, identification of NNPF may be nnpfa_id.
   b. In one example, identification of NNPF may be involved in SE_activation.
   c. In one example, more than one of identification of NNPF may be added into NNPFA SEI message.
      i. In one example, i-th filter may be indicated by nnpfa_id[i].
      ii. In one example, nnpfa_id[i] specifies that the i-th neural-network post-processing filter specified by one or more neural-network post-processing filter characteristics SEI messages that pertain to the current picture and have nnpfc_id equal to nnfpa_id[i] may be used for post-processing filtering for the current picture.
   d. In one example, the number of identifications of NNPF may depend on the color component.
   e. In one example, the number of identifications of NNPF may depend on the number of NNPF.
      i. In one example, the number of NNPF may be indicated by nnpfa_num_minus1.
      ii. In one example, the number of identifications of NNPF may be equal to the number of NNPF (nnpfa_num_minus1+1).
5) One or more syntax elements (expressed as SE region type) indicating the region type of NNPF may be added into NNPFA and/or NNPFC SEI message.
   a. In one example, region type of NNPF may be involved in SE_activation.
      i. In one example, region type of NNPF may be indicated by nnpfa_region_type.
   b. In one example, a region may be one type of video unit.
   c. In one example, one or more syntax elements indicating the region scope (SE region scope) of NNPF may be added into NNPFA SEI message for corresponding region type.
      i. In one example, region scope of NNPF may be involved in SE_activation.
         1. In one example, region scope of NNPF may be involved when region type is ROI.
      ii. In one example, region scope may depend on the region type.
      iii. In one example, region scope may be or be NOT signaled when the region type is identical to setting value.
         1. In one example, region type is a picture.
   d. In one example, a region may be whole or part or sub-region of a video/sequence/image.
      i. In one example, a region may be a sequence.
      ii. In one example, a region may be a picture.
      iii. In one example, a region may be a slice.
      iv. In one example, a region may be a tile/brick.
      v. In one example, a region may be a subpicture.
      vi. In one example, a region may be one or multiple CTUs/CTBs.
         1. In one example, one or more syntax elements indicating the identification of CTUs/CTBs of NNPF may be added into NNPFA SEI message when the region type is CTUs/CTBs.
         a. In one example, identification of CTUs/CTBs may be indicated by coordinate.
         b. In one example, identification of CTUs/CTBs may be indicated by index one by one (in sequence).
      vii. In one example, a region may be a CTU/CTB row.
         1. In one example, one or more syntax elements indicating the identification of CTU/CTB row of NNPF may be added into NNPFA SEI message when the region type is CTU/CTB row.
         a. In one example, identification of CTU/CTB row may be indicated by coordinate of CTU/CTB row.
         b. In one example, identification of CTU/CTB row may be indicated by index of CTU/CTB row one by one (in sequence).
      viii. In one example, a region may be one or multiple CUs/CBs.
         1. In one example, one or more syntax elements indicating the identification of CUs/CBs of NNPF may be added into NNPFA SEI message when the region type is CTUs/CTBs.
         a. In one example, identification of CUs/CBs may be indicated by coordinate.
         b. In one example, identification of CUs/CBs may be indicated by index one by one (in sequence).
      ix. In one example, a region may be one or multiple VPDU (Virtual Pipeline Data Unit).
         1. In one example, one or more syntax elements indicating the identification of VPDU of NNPF may be added into NNPFA SEI message when the region type is CTUs/CTBs.
         a. In one example, identification of VPDU may be indicated by coordinate.
         b. In one example, identification of VPDU may be indicated by index one by one (in sequence).
      x. In one example, a region may be a sub-region within a picture/slice/tile/brick.
   e. In one example, a region may be one or multiple patches of picture.
      i. In one example, one or more syntax elements indicating the size of patch of NNPF may be added into NNPFA SEI message when the region type is patch.
      ii. In one example, one or more syntax elements indicating the horizontal and/or vertical and/or total number of patches of NNPF may be added into NNPFA SEI message when the region type is patch.
   f. In one example, a region may be one or multiple regions of interest (ROI).
      i. In one example, one or more syntax elements indicating the initial point of ROI of NNPF may be added into NNPFA SEI message when the region type is ROI.
      ii. In one example, one or more syntax elements indicating the ending point of ROI of NNPF may be added into NNPFA SEI message when the region type is ROI.
      iii. In one example, one or more syntax elements indicating the horizontal samples (width) of ROI of NNPF may be added into NNPFA SEI message when the region type is ROI.
      iv. In one example, one or more syntax elements indicating the vertical samples (height) of ROI of NNPF may be added into NNPFA SEI message when the region type is ROI.
   g. In one example, region type of NNPF may be NOT signaled.
      i. In one example, region type may be set as a default type.
         1. In one example, region type may be picture level.
      ii. In one example, region type may have a lowest level.
         1. In one example, lowest level of region type may be patch level.
      iii. In one example, usage and/or switch and/or activation of NNPF may be indicated by a certain order.
         1. In one example, sequence level may be applied before picture level.
   h. In one example, nnpfa_region_type equal to 0 indicates that the SEI message activates one neural-network post-filter (NNPF) that is applied for the current picture.
      i. In one example, nnpfa_num_minus1 may be NOT signaled when nnpfa_region_type equal to 0.
   i. In one example, nnpfa_region_type greater than 0 indicates that the SEI message activates one or more NNPFs.
      i. In one example, when nnpfa_region_type is equal to 1, for each slice of the current picture, it is either indicated that no neural-network post-filtering is applied or the applied NNPF is indicated.
      ii. In one example, when nnpfa_region_type is equal to 2, for each CTU of the current picture, it is either indicated that no neural-network post-filtering is applied or the applied NNPF is indicated.
   j. In one example, the value of nnpfa_region_type shall be in the range of 0 to 31, inclusive. Values of nnpfa_region_type greater than 2 are reserved for future specification by ITU-T ISO/IEC and shall not be present in bitstreams conforming to this version of this Specification.
   k. In one example, decoders conforming to the Specification shall ignore NNPFA SEI messages with nnpfa_region_type greater than 2.
   l. In one example, nnpfa_region_type may be ue(v)-coded.
6) One or more syntax elements indicating usage and/or switch and/or activation of NNPF may be added into NNPFA SEI message.
   a. The syntax elements may depend on the region type.
      i. In one example, only syntax elements at the region level of specified region type may be added into NNPFA SEI message.
         1. In one example, NNPFA SEI message may comprise syntax element indicating NNPF at picture level when region type is picture.
         2. In one example, NNPFA SEI message may comprise syntax element indicating NNPF at slice level when region type is slice.
         a. In one example, the usage of NNPF at slice level may be indicated by nnpfa_slice_enabling_flag[i].
         i. In one example, only one NNPF is indicated by nnpfa_ia in NNPFA SEI message.
         b. In one example, the usage of NNPF at slice level may be indicated by nnpfa_slice_index[i].
         i. In one example, one or multiple NNPF are indicated by nnpfa_ia[i] in NNPFA SEI message.
         3. In one example, NNPFA SEI message may comprise syntax element indicating NNPF at CTU level when region type is CTU.
         a. In one example, the usage of NNPF at CTU level may be indicated by nnpfa_ctu_enabling_flag[i].
         i. In one example, only one NNPF is indicated by nnpfa_ia in NNPFA SEI message.
         b. In one example, the usage of NNPF at CTU level may be indicated by nnpfa_ctu_index[i].
         i. In one example, one or multiple NNPF are indicated by nnpfa_ia[i] in NNPFA SEI message.
   b. One or more syntax elements indicating usage of NNPF at the region (video unit) level may be added into NNPFA SEI message.
      i. In one example, syntax elements for different region level may be signaled following certain order.
         1. In one example, syntax element of higher region level may be signaled before lower region level.
         2. In one example, syntax element of region may be signaled when the region type is equal to nnpfa_region_type.
         a. In one example, nnpfa_slice_index[i] is signaled when nnpfa_region_type is equal to 1.
         b. In one example, nnpfa_slice_enabling_flag[i] is signaled when nnpfa_region_type is equal to 1.
         c. In one example, nnpfa_ctu_index[i] is signaled when nnpfa_region_type is equal to 2.
         d. In one example, nnpfa_ctu_enabling_flag[i] is signaled when nnpfa_region_type is equal to 2.
      ii. In one example, one syntax element may indicate whether the NNPF is used in the current region level.
         1. In one example, syntax element equal to 0 may indicates that the NNPF is not used in current region.
         a. In one example, syntax element may be nnpfa_slice_enabling_flag[i], nnpfa_ctu_enabling_flag[i].
         b. In one example, syntax element may be nnpfa_slice_index[i], nnpfa_ctu_index[i].
         2. In one example, syntax element equal to 1 may indicates that the NNPF is used in current region.
         a. In one example, syntax element may be nnpfa_slice_enabling_flag[i], nnpfa_ctu_enabling_flag[i].
         3. In one example, syntax element greater than 0 may indicates that the NNPF is used in current region.
         a. In one example, syntax element may be nnpfa_slice_index[i], nnpfa_ctu_index[i].
      iii. In one example, one syntax element may indicate how to select the NNPF in the current region level or which NNPF is used in the current region level.
         1. In one example, syntax element greater than 0 may indicates that the NNPF with index (syntax element −1) is used in current region.
         a. In one example, syntax element may be nnpfa_slice_index[i], nnpfa_ctu_index[i].
         2. In one example, syntax element smaller than maxNnpfNum may indicates that the NNPF with index (syntax element) is used in current region.
      iv. In one example, one syntax element may indicate whether the NNPF is adaptively used in the next (lower) region level.
         1. In one example, syntax element equal to 0 may indicates that the NNPF is adaptively selected in next region level.
         2. In one example, syntax element equal to maxNnpfNum may indicates that the NNPF is adaptively selected in next region level.
         3. In one example, syntax element equal to (maxNnpfNum−1) may indicates that the NNPF is adaptively selected in next region level.
      v. In one example, the signaling of syntax element at current region level may depend on the syntax element at previous (higher) region level.
      vi. In one example, area of region A is larger than the area of region B may indicates that level of region A is greater than level of region B and level of region B is lower than level of region A.
         1. In one example, picture level is lower than sequence level.
         2. In one example, slice level is lower than picture level.
         3. In one example, CTU level is lower than slice level.
         4. In one example, CU level is lower than CTU level.
         5. In one example, CU level is lower than CTU level.
   c. One or more syntax elements indicating usage of NNPF at the sequence level may be added into NNPFA SEI message.
      i. In one example, syntax element may indicate that NNPF is applied at sequence level or a lower level.
      ii. In one example, syntax element at sequence level may be NOT signaled.
   d. One or more syntax elements indicating usage of NNPF at the TID level may be added into NNPFA SEI message.
      i. In one example, syntax element at TID level may depend on the syntax element at higher level.
      ii. In one example, syntax element may indicate that NNPF is applied at TID level or a lower level.
         1. In one example, syntax element indicating TID index may be added into NNPFA SEI message.
      iii. In one example, syntax element at TID level may be NOT signaled.
   e. One or more syntax elements indicating usage of NNPF at the picture level may be added into NNPFA SEI message.
      i. In one example, syntax element at picture level may depend on the syntax element at higher level.
      ii. In one example, syntax element may indicate that NNPF is applied at picture level or a lower level.
      iii. In one example, syntax element may indicate that NNPF is applied or not at picture level.
      iv. In one example, syntax element may indicate that index of NNPF which is applied at picture level.
      v. In one example, syntax element at picture level may be NOT signaled.
   f. One or more syntax elements indicating usage of NNPF at the slice level may be added into NNPFA SEI message.
      i. In one example, syntax element at slice level may depend on the syntax element at higher level.
      ii. In one example, syntax element may indicate that NNPF is applied at slice level or a lower level.
      iii. In one example, syntax element at slice level may be NOT signaled.
      iv. In one example, usage of NNPF at the slice level may be indicated by nnpfa_slice_enabling_flag[i].
         1. In one example, nnpfa_slice_enabling_flag[i] equal to 1 indicates that the post-processing filter is used for the i-th slice of the current picture.
         2. In one example, nnpfa_slice_enabling_flag[i] equal to 0 indicates that the post-processing filter is not used for the i-th slice of the current picture.
      v. In one example, usage of NNPF at the slice level may be indicated by nnpfa_slice_index[i].
         1. In one example, nnpfa_slice_index[i] equal to 0 indicates that neural-network post-filtering is not used for the i-th slice of the current picture.
         2. In one example, nnpfa_slice_index[i] greater than 0 indicates that the NNPF with nnpfc_id equal to nnpfa_id[nnpfa_slice_index[i]−1] is used for the i-th slice of the current picture.
         3. In one example, the value of nnpfa_slice_index[i] shall be in the range of 0 to nnpfa_num_minus1+1, inclusive.
   g. One or more syntax elements indicating usage of NNPF at the sub block/CTU/CTB/patch level may be added into NNPFA SEI message.
      i. In one example, syntax element at sub block/CTU/CTB/patch level may depend on the syntax element at higher level (e.g., picture/slice/sequence level).
      ii. In one example, syntax element may indicate that NNPF is applied or not at block/CTU/CTB/patch level.
      iii. In one example, syntax element may indicate that index of NNPF which is applied at block/CTU/CTB/patch level.
      iv. In one example, syntax element may indicate that NNPF is applied at sub block/CTU/CTB/patch level or a lower level.
      v. In one example, syntax element at sub block/CTU/CTB/patch level may be NOT signaled.
      vi. In one example, usage of NNPF at the CTU level may be indicated by nnpfa_ctu_enabling_flag[i].
         1. In one example, nnpfa_ctu_enabling_flag[i] equal to 1 indicates that the post-processing filter is used for the i-th CTU of the current picture.
         2. In one example, nnpfa_ctu_enabling_flag[i] equal to 0 indicates that the post-processing filter is not used for the i-th CTU of the current picture.
      vii. In one example, usage of NNPF at the CTU level may be indicated by nnpfa_ctu_index[i].
         1. In one example, nnpfa_ctu_index[i] equal to 0 indicates that neural-network post-filtering is not used for the i-th CTU of the current picture.
         2. In one example, nnpfa_ctu_index[i] greater than 0 indicates that the NNPF with nnpfc_id equal to nnpfa_id[nnpfa_ctu_index[i]−1] is used for the i-th CTU of the current picture.
         3. In one example, the value of nnpfa_ctu_index[i] shall be in the range of 0 to nnpfa_num_minus1+1, inclusive.
   h. One or more syntax elements indicating usage of NNPF at the ROI level may be added into NNPFA SEI message.
      i. In one example, syntax element at ROI level may depend on the syntax element at higher level.
      ii. In one example, syntax element may indicate that NNPF is applied at ROI level or a lower level.
      iii. In one example, syntax element at ROI level may be NOT signaled.
   i. In one example, the syntax element in NNPFA SEI message may be used for the same video unit/region until meeting a new sequence/SEI.
   j. In one example, the syntax element in NNPFA SEI message may be used for the nearest video unit/region.
7) One or more syntax elements indicating improvement/promotion of NNPF may be added into NNPFA and/or NNPFC SEI message.
   a. One or more syntax elements indicating performance indicator (or purpose) of NNPF may be added into NNPFA and/or NNPFC SEI message.
      i. In one example, purpose may be improving subjective/objective quality.
   b. One or more syntax elements indicating performance level of NNPF may be added into NNPFA and/or NNPFC SEI message.
      i. In one example, performance level may be normalized value.
      ii. In one example, performance level may be different or same for different performance indicator (purpose).
   c. One or more syntax elements indicating complexity level of NNPF may be added into NNPFA and/or NNPFC SEI message.
      i. In one example, complexity level may be normalized value.
8) It is proposed that the multiple NNPF and/or characteristics of NNPF may be indicated by adding one or multiple groups of syntax elements into NNPFC SEI message.
   a. In one example, one or more syntax elements indicating the number of NNPF may be added into NNPFC SEI message.
      i. In one example, the syntax element may be expressed as nnpfc_num_minus1.
         1. In one example, the number of NNPF may be equal to nnpfc_num_minus1+1.
         2. In one example, the value of nnpfc_num_minus1 shall be in the range of 0 to 2^{k}-1, inclusive.
         a. In one example, k may be integer, such as 0, 1, 2, 3, 4, 5, 6, 7, . . . , 32.
      ii. In one example, the number of NNPF may be ue(v)-coded.
      iii. In one example, the number of NNPF may be smaller than the max value of nnpfc_id plus one.
   b. In one example, the number of NNPF may be not signaled into NNPFC SEI message.
      i. In one example, the number of NNPF may be set as default value.
      ii. In one example, the number of NNPF may be 1, 2, 3, 4, 5.
   c. In one example, the number of multiple groups of syntax elements indicating characteristics of NNPF may depend on the number of multiple sets of NNPF.
      i. In one example, the number of groups of syntax elements indicating characteristics of NNPF may equal to the number of NNPF.
   d. In one example, multiple groups of syntax elements indicating characteristics of NNPF may be signaled for each/all/different NNPF.
      i. In one example, every NNPF may have one group of syntax elements indicating characteristics of NNPF.
      ii. In one example, multiple groups of syntax elements may be signaled following a certain order.
         1. In one example, the group of syntax elements may be signaled one by one.
      iii. In one example, i^{th} group of syntax elements indicating characteristics of NNPF may be used for i^{th} NNPF.
         1. In one example, 1^{st} group of syntax elements indicating characteristics of NNPF may be used for 1^{st} NNPF.
         2. In one example, 2^{nd} group of syntax elements indicating characteristics of NNPF may be used for 2^{nd} NNPF.
         3. In one example, 3^{rd} group of syntax elements indicating characteristics of NNPF may be used for 3^{rd} NNPF.
      iv. In one example, the design of each group of syntax elements may be same.
         1. In one example, the number and/or items of each group of syntax elements may be same.
         2. In one example, nnpfc_id may be involved in every group of syntax elements.
         3. In one example, nnpfc_mode_idc may be involved in every group of syntax elements.

### 6. Embodiments

Below are some example embodiments for the solution aspects summarized above in Section 5.

Most relevant parts that have been added or modified are shown by using bolded words (e.g., this format indicates added text), and some of the deleted parts are shown by using words in italics between double curly brackets (e.g., [[this format indicates deleted text]]). There may be some other changes that are editorial in nature and thus not highlighted. It should be understood that only markings in this section are intended to emphasize at least part of proposed changes.

### 6.1. Embodiment 1

8.28.1 Neural-network post-filter characteristics SEI message syntax

| | Descriptor |
|---|---|
| nn_post_filter_characteristics( payloadSize ) { | |
| nnpfc_{—}num_{—}minus1 | ue(v) |
| for( n = 0; n < nnpfcNum; n++ ) { | |
| nnpfc_id | ue(v) |
| nnpfc_mode_idc | ue(v) |
| nnpfc_purpose_and_formatting_flag | u(1) |
| if( nnpfc_purpose_and_formatting_flag ) { | |
| nnpfc_purpose | ue(v) |
| if( nnpfc_purpose = = 2 \| \| nnpfc_purpose = = 4 ) | |
| nnpfc_out_sub_c_flag | u(1) |
| if( nnpfc_purpose = = 3 \| \| nnpfc_purpose = = 4 ) { | |
| nnpfc_pic_width_in_luma_samples | ue(v) |
| nnpfc_pic_height_in_luma_samples | ue(v) |
| } | |
| /* input and output formatting */ | |
| nnpfc_component_last_flag | u(1) |
| nnpfc_inp_format_flag | u(1) |
| if( nnpfc_inp_format_flag = = 1 ) | |
| nnpfc_inp_tensor_bitdepth_minus8 | ue(v) |
| nnpfc_inp_order_idc | ue(v) |
| nnpfc_auxiliary_inp_idc | ue(v) |
| nnpfc_separate_colour_description_present_flag | u(1) |
| if( nnpfc_separate_colour_description_present_flag ) { | |
| nnpfc_colour_primaries | u(8) |
| nnpfc_transfer_characteristics | u(8) |
| nnpfc_matrix_coeffs | u(8) |
| } | |
| nnpfc_out_format_flag | u(1) |
| if( nnpfc_out_format_flag = = 1 ) | |
| nnpfc_out_tensor_bitdepth_minus8 | ue(v) |
| nnpfc_out_order_idc | ue(v) |
| nnpfc_constant_patch_size_flag | u(1) |
| nnpfc_patch_width_minus1 | ue(v) |
| nnpfc_patch_height_minus1 | ue(v) |
| nnpfc_overlap | ue(v) |
| nnpfc_padding_type | ue(v) |
| if( nnpfc_padding_type = = 4 ){ | |
| nnpfc_luma_padding_val | ue(v) |
| nnpfc_cb_padding_val | ue(v) |
| nnpfc_cr_padding_val | ue(v) |
| } | |
| nnpfc_complexity_idc | ue(v) |
| if( nnpfc_complexity_idc > 0 ) | |
| nnpfc_complexity_element( nnpfc_complexity_idc ) | |
| if( nnpfc_mode_idc = = 2 ) { | |
| while( !byte_aligned( ) ) | |
| nnpfc_reserved_zero_bit | u(1) |
| nnpfc_uri_tag[ i ] | st(v) |
| nnpfc_uri[ i ] | st(v) |
| } | |
| } | |
| /* filter specified or updated by ISO/IEC 15938-17 bitstream */ | |
| if( nnpfc_mode_idc = = 1 ) { | |
| while( !byte_aligned( ) ) | |
| nnpfc_reserved_zero_bit | u(1) |
| for( i = 0; more_data_in_payload( ); i++ ) | |
| nnpfc_payload_byte[ i ] | b(8) |
| } | |
| } | |
| } | |

8.28.2 Neural-network post-filter characteristics SEI message semantics
nnpfc_{—}num_{—}minus1 indicates the maximum number of neural-network post processing filter. The
value nnpfc_{—}num_{—}minus1 shall be in the range of 0 to 2³² − 2, inclusive. The variable nnpfcNum is
derived as:

| | |
|---|---|
| nnpfcNum = nnpfc_{—}num_{—}minus1 + 1 | (1) |

### 6.2. Embodiment 2

8.29.1 Neural-network post-filter activation SEI message syntax

| | Descriptor |
|---|---|
| nn_post_filter_activation( payloadSize ) { | |
| nnpfa_{—}num_{—}minus1 | ue(v) |
| for( n = 0; n < nnpfaNum; n++ ) { | |
| nnpfa_id | ue(v) |
| } | |
| } | |

8.29.2 Neural-network post-filter activation SEI message semanitcs
nnpfa_{—}num_{—}minus1 indicates the maximum number of neural-network post processing filter. The
value nnpfa_{—}num_{—}minus1 shall be in the range of 0 to 2³² − 2, inclusive. The variable nnpfcNum is
derived as:

| | |
|---|---|
| nnpfaNum = nnpfa_{—}num_{—}minus1 + 1 | (2) |

### 6.3. Embodiment 3

8.29.3 Neural-network post-filter activation SEI message syntax

| | Descriptor |
|---|---|
| nn_post_filter_activation( payloadSize ) { | |
| nnpfa_id | ue(v) |
| nnpfa_{—}region_{—}type | ue(v) |
| if (nnpfa_{—}region_{—}type == 1) { | |
| for (i = 0; i < maxSliceNum; i++) { | |
| nnpfa_{—}slice_{—}enabling_{—}flag | u(1) |
| } | |
| } else if (nnpfa_{—}region_{—}type == 2) { | |
| for (i = 0; i < maxCtuNum; i++) { | |
| nnpfa_{—}ctu_{—}enabling_{—}flag | u(1) |
| } | |
| } | |
| } | |

8.29.4 Neural-network post-filter activation SEI message semanitcs
maxSliceNum is the max number of slices in current picture.
maxCtuNum is the max number of coding tree unit in current picture.
nnpfa_{—}region_{—}type indicates the region type of using the post-processing filter as specified in Table 1.
The value of nnpfa_{—}region_{—}type shall be in the range of 0 to 2³² − 2, inclusive. nnpfa_region_type
equal to 0 specifies that post-processing filter is used in picture. nnpfa_{—}region_{—}type equal to 1 specifies
that post-processing filter is applied in slice and usage in slice may be determined later.
nnpfa_{—}region_{—}type equal to 2 specifies that post-processing filter is applied in slice and usage in CTU
may be determined later.

Table 1 - Definition of nnpfa_region_type

| Value | Interpretation |
|---|---|
| 0 | Picture, always use post-processing filter in current picture |
| 1 | Slice |
| 2 | CTU |

nnpfa_{—}slice_{—}enabling_{—}flag equal to 1 specifies that post-processing filter is used to the
current slice.
nnpfa_{—}slice_{—}enabling_{—}flag equal to 0 specifies that post-processing filter is not used to
the current slice.
nnpfa_{—}ctu_{—}enabling_{—}flag equal to 1 specifies that post-processing filter is used to the
current CTU.
nnpfa_{—}ctu_{—}enabling_{—}flag equal to 0 specifies that post-processing filter is not used to
the current CTU.

### 6.4. Embodiment 4

8.29.5 Neural-network post-filter activation SEI message syntax

| | Descriptor |
|---|---|
| nn_post_filter_activation( payloadSize ) { | |
| nnpfa_{—}num_{—}minus1 | ue(v) |
| for( n = 0; n < nnpfaNum; n++ ) { | |
| nnpfa_id | ue(v) |
| } | |
| nnpfa_{—}region_{—}type | ue(v) |
| if (nnpfa_{—}region_{—}type == 0) { | |
| nnpfa_{—}picture_{—}index | ue(v) |
| } else if (nnpfa_{—}region_{—}type == 1) { | |
| for (i = 0; i < maxSliceNum; i++) { | |
| nnpfa_{—}slice_{—}index | ue(v) |
| } | |
| } else if (nnpfa_{—}region_{—}type == 2) { | |
| for (i = 0; i < maxCtuNum; i++) { | |
| nnpfa_{—}ctu_{—}index | ue(v) |
| } | |
| } | |
| } | |

8.29.6 Neural-network post-filter activation SEI message semanitcs
maxCtuNum is the max number of coding tree unit in current picture.
nnpfa_{—}num_{—}minus1 indicates the maximum number of neural-network post processing filter. The
value nnpfa_{—}num_{—}minus1 shall be in the range of 0 to 2³² − 2, inclusive. The variable nnpfcNum is
derived as:

| | |
|---|---|
| nnpfaNum = nnpfa_{—}num_{—}minus1 + 1 | (2) |

nnpfa_{—}region_{—}type indicates the region type of using the post-processing filter as specified in Table 1.
The value of nnpfa_{—}region_{—}type shall be in the range of 0 to 2³² − 2, inclusive. nnpfa_region_type
equal to 0 specifies that post-processing filter is applied in picture and usage in picture may be
determined later. nnpfa_{—}region_{—}type equal to 1 specifies that post-processing filter is applied in slice
and usage in slice may be determined later. nnpfa_{—}region_{—}type equal to 2 specifies that post-
processing filter is applied in slice and usage in CTU may be determined later.

Table 1 - Definition of nnpfa_region_type

| Value | Interpretation |
|---|---|
| 0 | Picture |
| 1 | Slice |
| 2 | CTU |

nnpfa_{—}picture_{—}index indicates the usage of post-processing filter in picture. When nnpfa_{—}picture_{—}index
equal to 0 specifies that post-processing filter is not used to the current picture. When
nnpfa_{—}picture_{—}index greater than 0 specifies that post-processing filter with the index
(nnpfa_{—}picture_{—}index − 1) is used to the current picture.
nnpfa_{—}ctu_{—}index indicates the usage of post-processing filter in CTU. When nnpfa_{—}ctu_{—}index equal to
0 specifies that post-processing filter is not used to the current CTU. When nnpfa_{—}ctu_{—}index greater
than 0 specifies that post-processing filter with the index (nnpfa_{—}ctu_{—}index − 1) is used to the current
CTU.

### 6.5. Embodiment 5

8.29.7 Neural-network post-filter activation SEI message syntax

| | Descriptor |
|---|---|
| nn_post_filter_activation( payloadSize ) { | |
| nnpfa_id | ue(v) |
| nnpfa_{—}picture_{—}index | u(1) |
| if (nnpfa_{—}picture_{—}index == 0) { | |
| for (i = 0; i < maxCtuNum; i++) { | |
| nnpfa_{—}ctu_{—}index | u(1) |
| } | |
| } | |
| } | |

8.29.8 Neural-network post-filter activation SEI message semanitcs
maxCtuNum is the max number of coding tree unit in current picture.
nnpfa_{—}picture_{—}index indicates the usage of post-processing filter in picture. When nnpfa_{—}picture_{—}index
equal to 1 specifies that post-processing filter is used in the current picture. When nnpfa_{—}picture_{—}index
equal to 0 specifies that post-processing filter is adaptively used in CTU.
nnpfa_{—}ctu_{—}index indicates the usage of post-processing filter in CTU. When nnpfa_{—}ctu_{—}index equal to
0 specifies that post-processing filter is not used to the current CTU. When nnpfa_{—}ctu_{—}index equal to 1
specifies that post-processing filter is used to the current CTU.

### 6.6. Embodiment 6

8.29.9 Neural-network post-filter activation SEI message syntax

| | Descriptor |
|---|---|
| nn_post_filter_activation( payloadSize ) { | |
| nnpfa_{—}num_{—}minus1 | ue(v) |
| for( n = 0; n < nnpfaNum; n++ ) { | |
| nnpfa_id | ue(v) |
| } | |
| nnpfa_{—}picture_{—}index | ue(v) |
| if (nnpfa_{—}picture_{—}index == nnpfaNum) { | |
| for (i = 0; i < maxCtuNum; i++) { | |
| nnpfa_{—}ctu_{—}index | ue(v) |
| } | |
| } | |
| } | |

8.29.10 Neural-network post-filter activation SEI message semanitcs
maxCtuNum is the max number of coding tree unit in current picture.
nnpfa_{—}num_{—}minus1 indicates the maximum number of neural-network post processing filter. The
value nnpfa_{—}num_{—}minus1 shall be in the range of 0 to 2³² − 2, inclusive. The variable nnpfcNum is
derived as:

| | |
|---|---|
| nnpfaNum = nnpfa_{—}num_{—}minus1 + 1 | (2) |

nnpfa_{—}picture_{—}index indicates the usage of post-processing filter in picture. When nnpfa_{—}picture_{—}index
smaller than maxCtuNum specifies that post-processing filter with the index (nnpfa_{—}picture_{—}index) is
used in the current picture. When nnpfa_{—}picture_{—}index equal to maxCtuNum specifies that post-
processing filter is adaptively used in CTU.
nnpfa_{—}ctu_{—}index indicates the usage of post-processing filter in CTU. When nnpfa_{—}ctu_{—}index equal to
0 specifies that post-processing filter is not used to the current CTU. When nnpfa_{—}ctu_{—}index greater
than 0 specifies that post-processing filter with the index (nnpfa_{—}ctu_{—}index − 1) is used to the current
CTU.

### 6.7. Embodiment 7

8.29.1 Neural-network post-filter activation SEI message syntax

| | Descriptor |
|---|---|
| nn_post_filter_activation( payloadSize ) { | |
| nnpfa_id | ue(v) |
| nnpfa_{—}region_{—}type | ue(v) |
| if (nnpfa_{—}region_{—}type == 1) { | |
| for (i = 0; i < maxSliceNum; i++) { | |
| nnpfa_{—}slice_{—}enabling_{—}flag | u(1) |
| } | |
| } else if (nnpfa_{—}region_{—}type == 2) { | |
| for (i = 0; i < maxCtuNum; i++) { | |
| nnpfa_{—}ctu_{—}enabling_{—}flag | u(1) |
| } | |
| } | |
| } | |

8.29.2 Neural-network post-filter activation SEI message semantics
maxSliceNum is the max number of slices in current picture.
maxCtuNum is the max number of coding tree unit in current picture.
nnpfa_{—}region_{—}type indicates the region type of using the post-processing filter as specified in
Table 1. The value of nnpfa_{—}region_{—}type shall be in the range of 0 to 2³² − 2, inclusive.
nnpfa_{—}region_{—}type equal to 0 specifies that post-processing filter is used for picture.
nnpfa_{—}region_{—}type equal to 1 specifies that post-processing filter is applied for slice and usage in
slice may be determined later. nnpfa_{—}region_{—}type equal to 2 specifies that post-processing filter is
applied for CTU and usage in CTU may be determined later. Values of nnpfa_{—}region_{—}type that do
not appear in Table 1 are reserved for future specification by ITU-T | ISO/IEC and shall not be
present in bitstreams conforming to this version of this Specification. Decoders conforming to this
version of this Specification shall ignore SEI messages that contain reserved values of
nnpfa_{—}region_{—}type.

Table 1 - Definition of nnpfa_region_type

| Value | Interpretation |
|---|---|
| 0 | The post-processing filter is used for picture level and is activated for current |
| | picture. |
| 1 | The post-processing filter is used for slice level and the usage of each slice can be |
| | determined independently. |
| 2 | The post-processing filter is used for CTU level and the usage of each CTU can be |
| | determined independently. |
| nnpfa_{—}slice_{—}enabling_{—}flag equal to 1 specifies that post-processing filter is used to the current slice. | |
| nnpfa_{—}slice_{—}enabling_{—}flag equal to 0 specifies that post-processing filter is not used to the current | |
| slice. The value of nnpfa_{—}slice_{—}enabling_{—}flag shall be in the range of 0 to 1, inclusive. | |
| nnpfa_{—}ctu_{—}enabling_{—}flag equal to 1 specifies that post-processing filter is used to the current CTU. | |
| nnpfa_{—}ctu_{—}enabling_{—}flag equal to 0 specifies that post-processing filter is not used to the current CTU. | |
| The value of nnpfa_{—}ctu_{—}enabling_{—}flag shall be in the range of 0 to 1, inclusive. | |

### 6.8. Embodiment 8

8.29.1 Neural-network post-filter activation SEI message syntax

| | Descriptor |
|---|---|
| nn_post_filter_activation( payloadSize ) { | |
| nnpfa_{—}num_{—}minus1 | ue(v) |
| for( n = 0; n < nnpfaNum; n++ ) { | |
| nnpfa_id | ue(v) |
| } | |
| nnpfa_{—}region_{—}type | ue(v) |
| if (nnpfa_{—}region_{—}type == 0) { | |
| nnpfa_{—}picture_{—}index | ue(v) |
| } else if (nnpfa_{—}region_{—}type == 1) { | |
| for (i = 0; i < maxSliceNum; i++) { | |
| nnpfa_{—}slice_{—}index | ue(v) |
| } | |
| } else if (nnpfa_{—}region_{—}type == 2) { | |
| for (i = 0; i < maxCtuNum; i++) { | |
| nnpfa_{—}ctu_{—}index | ue(v) |
| } | |
| } | |
| } | |

8.29.2 Neural-network post-filter activation SEI message semantics
maxSliceNum is the max number of slices in current picture.
maxCtuNum is the max number of coding tree unit in current picture.
nnpfa_{—}num_{—}minus1 indicates the number the number of neural-network post-processing filter.
nnpfa_{—}num_{—}minus1 shall be in the range of 0 to 2³² − 2, inclusive. The variable nnpfcNum is
derived as:

| | |
|---|---|
| nnpfaNum = nnpfa_{—}num_{—}minus1 + 1 | (1) |

nnpfa_{—}region_{—}type indicates the region type of using the post-processing filter as specified in
Table 1. The value of nnpfa_{—}region_{—}type shall be in the range of 0 to 2³² − 2, inclusive.
nnpfa_{—}region_{—}type equal to 0 specifies that post-processing filter is applied in picture and usage in
picture may be determined later. nnpfa_{—}region_{—}type equal to 1 specifies that post-processing filter
is applied in slice and usage in slice may be determined later. nnpfa_{—}region_{—}type equal to 2
specifies that post-processing filter is applied in CTU and usage in CTU may be determined later.
Values of nnpfa_{—}region_{—}type that do not appear in Table 1 are reserved for future specification by
ITU-T | ISO/IEC and shall not be present in bitstreams conforming to this version of this
Specification. Decoders conforming to this version of this Specification shall ignore SEI messages
that contain reserved values of nnpfa_{—}region_{—}type.

Table 1 - Definition of nnpfa_region_type

| Value | Interpretation |
|---|---|
| 0 | The post-processing filter is used for picture level and multiple filters can be selected |
| | for picture. |
| 1 | The post-processing filter is used for slice level and multiple filters can be selected for |
| | each slice. |
| 2 | The post-processing filter is used for CTU level and multiple filters can be selected for |
| | each CTU. |

nnpfa_{—}picture_{—}index indicates the usage of post-processing filter for picture. When
nnpfa_{—}picture_{—}index equal to 0 specifies that post-processing filter is not used for the current
picture. When nnpfa_{—}picture_{—}index greater than 0 specifies that post-processing filter with the
index (nnpfa_{—}picture_{—}index − 1) is used for the current picture. The value of nnpfa_{—}picture_{—}index
shall be in the range of 0 to Min(2³² − 1, nnpfaNum), inclusive.
nnpfa_{—}slice_{—}index indicates the usage of post-processing filter for slice. When nnpfa_{—}slice_{—}index
equal to 0 specifies that post-processing filter is not used for the current slice. When
nnpfa_{—}slice_{—}index greater than 0 specifies that post-processing filter with the index
(nnpfa_{—}slice_{—}index − 1) is used for the current slice. The value of nnpfa_{—}slice_{—}index shall be in the
range of 0 to Min(2³² − 1, nnpfaNum).
nnpfa_{—}ctu_{—}index indicates the usage of post-processing filter in CTU. When nnpfa_{—}ctu_{—}index
equal to 0 specifies that post-processing filter is not used for the current CTU. When
nnpfa_{—}ctu_{—}index greater than 0 specifies that post-processing filter with the index
(nnpfa_{—}ctu_{—}index − 1) is used for the current CTU. The value of nnpfa_{—}ctu_{—}index shall be in the
range of 0 to Min(2³² − 1, nnpfaNum).

6.9. Embodiment 9

8.29.1 Neural-network post-filter activation SEI message syntax

| | Descriptor |
|---|---|
| nn_post_filter_activation( payloadSize ) { | |
| nnpfa_id | ue(v) |
| nnpfa_{—}region_{—}type | ue(v) |
| if( nnpfa_{—}region_{—}type = = 1) | |
| for( i = 0; i < numSlices; i++) | |
| nnpfa_{—}slice_{—}enabling_{—}flag[ i ] | u(1) |
| else if( nnpfa_{—}region_{—}type = = 2 ) | |
| for( i = 0; i < numCtus; i++) | |
| nnpfa_{—}ctu_{—}enabling_{—}flag[ i ] | u(1) |
| } | |

8.29.2 Neural-network post-filter activation SEI message semantics
nnpfa_{—}region_{—}type indicates the region type of using the post-processing filter. nnpfa_{—}region_{—}type
equal to 0 indicates that the post-processing filter is used for the current picture. nnpfa_{—}region_{—}type
equal to 1 indicates that the post-processing filter is applied for some slices of the current picture.
nnpfa_{—}region_{—}type equal to 2 indicates that the post-processing filter is applied for some CTUs of
the current picture. The value of nnpfa_{—}region_{—}type shall be in the range of 0 to 31, inclusive. Values
of nnpfa_{—}region_{—}type greater than 2 are reserved for future specification by ITU-T | ISO/IEC and
shall not be present in bitstreams conforming to this version of this Specification. Decoders
conforming to this version of this Specification shall ignore NNPFA SEI messages with
nnpfa_{—}region_{—}type greater than 2.
If nnpfa_{—}region_{—}type is equal to 1, the variable numSlices is set equal to the number of slices in the
current picture. Otherwise, when nnpfa_{—}region_{—}type is equal to 2, the variable numCTUs is set
equal to the number of CTUs in the current picture.
nnpfa_{—}slice_{—}enabling_{—}flag[ i ] equal to 1 indicates that the post-processing filter is used for the i-th
slice of the current picture. nnpfa_{—}slice_{—}enabling_{—}flag[ i ] equal to 0 indicates that the post-
processing filter is not used for the i-th slice of the current picture.
nnpfa_{—}ctu_{—}enabling_{—}flag[ i ] equal to 1 indicates that the post-processing filter is used for the i-th
CTU of the current picture. nnpfa_{—}ctu_{—}enabling_{—}flag equal to 0 indicates that the post-processing
filter is not used for the i-th CTU of the current picture.

### 6.10. Embodiment 10

8.29.1 Neural-network post-filter activation SEI message syntax

| | Descriptor |
|---|---|
| nn_post_filter_activation( payloadSize ) { | |
| nnpfa_{—}region_{—}type | ue(v) |
| if( nnpfa_{—}region_{—}type > 0 ) | |
| nnpfa_{—}num_{—}minus1 | ue(v) |
| for( i = 0; i <= nnpfa_{—}num_{—}minus1; i++ ) | |
| nnpfa_{—}id[ i ] | ue(v) |
| if( nnpfa_{—}region_{—}type = = 1 ) | |
| for (i = 0; i < numSlices; i++) | |
| nnpfa_{—}slice_{—}index[ i ] | ue(v) |
| else if( nnpfa_{—}region_{—}type = = 2 ) | |
| for( i = 0; i < numCtus; i++ ) | |
| nnpfa_{—}ctu_{—}index[ i ] | ue(v) |
| } | |

8.29.2 Neural-network post-filter activation SEI message semantics
nnpfa_{—}region_{—}type indicates the region type of using the post-processing filter. nnpfa_{—}region_{—}type
equal to 0 indicates that the SEI message activates one neural-network post-filter (NNPF) that is
applied for the current picture. nnpfa_{—}region_{—}type greater than 0 indicates that the SEI message
activates one or more NNPFs. When nnpfa_{—}region_{—}type is equal to 1, for each slice of the current
picture, it is either indicated that no neural-network post-filtering is applied or the applied NNPF is
indicated. When nnpfa_{—}region_{—}type is equal to 2, for each CTU of the current picture, it is either
indicated that no neural-network post-filtering is applied or the applied NNPF is indicated. The
value of nnpfa_{—}region_{—}type shall be in the range of 0 to 31, inclusive. Values of nnpfa_{—}region_{—}type
greater than 2 are reserved for future specification by ITU-T | ISO/IEC and shall not be present in
bitstreams conforming to this version of this Specification. Decoders conforming to this version of
this Specification shall ignore NNPFA SEI messages with nnpfa_{—}region_{—}type greater than 2.
If nnpfa_{—}region_{—}type is equal to 1, the variable numSlices is set equal to the number of slices in the
current picture. Otherwise, when nnpfa_{—}region_{—}type is equal to 2, the variable numCTUs is set
equal to the number of CTUs in the current picture.
nnpfa_{—}num_{—}minus1 plus 1 indicates the number of NNPFs activated by the SEI message. The value
of nnpfa_{—}num_{—}minus1 shall be in the range of 0 to 255, inclusive. When not present, the value of
nnpfa_{—}num_{—}minus1 is inferred to be equal to 0.
nnpfa_{—}id[ i ] specifies that the i-th neural-network post-processing filter specified by one or more neural-
network post-processing filter characteristics SEI messages that pertain to the current picture and have
nnpfc_{—}id equal to nnfpa_{—}id[ i ] may be used for post-processing filtering for the current picture.
nnpfa_{—}slice_{—}index[ i ] indicates the usage of neural-network post-filtering for the i-th slice of the
current picture. nnpfa_{—}slice_{—}index[ i ] equal to 0 indicates that neural-network post-filtering is not
used for the i-th slice of the current picture. nnpfa_{—}slice_{—}index[ i ] greater than 0 indicates that the
NNPF with nnpfc_{—}id equal to nnpfa_{—}id[ nnpfa_{—}slice_{—}index[ i ] − 1 ] is used for the i-th slice of the
current picture. The value of nnpfa_{—}slice_{—}index[ i ] shall be in the range of 0 to
nnpfa_{—}num_{—}minus1 + 1, inclusive.
nnpfa_{—}ctu_{—}index[ i ] indicates the usage of neural-network post-filtering for the i-th CTU of the
current picture. nnpfa_{—}ctu_{—}index[ i ] equal to 0 indicates that neural-network post-filtering is not
used for the i-th CTU of the current picture. nnpfa_{—}ctu_{—}index[ i ] greater than 0 indicates that the
NNPF with nnpfc_{—}id equal to nnpfa_{—}id[ nnpfa_{—}ctu_{—}index[ i ] − 1 ] is used for the i-th CTU of the
current picture. The value of nnpfa_{—}ctu_{—}index[ i ] shall be in the range of 0 to
nnpfa_{—}num_{—}minus1 + 1, inclusive.

More details of the embodiments of the present disclosure will be described below which are related to extension of neural-network post-filter activation and neural-network post-filter characteristics. The embodiments of the present disclosure should be considered as examples to explain the general concepts and should not be interpreted in a narrow way. Furthermore, these embodiments can be applied individually or combined in any manner.

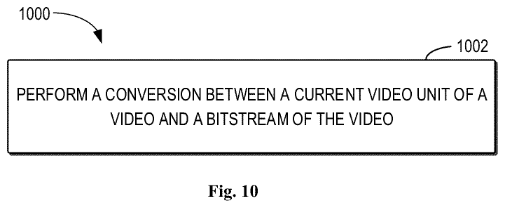

FIG. 10 illustrates a flowchart of a method 1000 for video processing in accordance with some embodiments of the present disclosure. As shown in FIG. 10, at 1002, a conversion between a current video unit of a video and a bitstream of the video is performed. In some embodiments, the conversion may include encoding the current video unit into the bitstream. Alternatively or additionally, the conversion may include decoding the current video unit from the bitstream.

In some embodiments, the bitstream comprises at least one set of syntax elements for activating at least one neural-network post-filter (NNPF) for the current video unit. The current video unit is a portion of a current picture of the video. In other words, a level of the current video unit may be lower than the picture level. Thereby, the activation of NNPF may be controlled at a level lower than the picture level, such as a slice level, a tile level or the like.

It should be noted that that the terms “activation”, “enabling”, “presence” and “usage” may be used interchangeably herein. For example, the activation of an NNPF may also be referred to as the enabling, the presence or the usage of the NNPF. Moreover, the terms “neural-network post-filter” and “neural-network post-processing filter” may also be used interchangeably.

By way of example rather than limitation, a single NNPF may be activated and used for the current video unit in the current picture, while no NNPF is applied on the rest portion of the current picture.

Alternatively, one or more further NNPFs different from the single NNPF is activated and used for the rest portion of the current picture. In a further example, instead of only a single NNPF, a plurality of different NNPFs is activated and used for different portions of the current video unit. Furthermore, the activation of such NNPF(s) may be indicated in the bitstream in aid of one or more sets of syntax elements.

In view of the above, the activation of one or more NNPFs may be controlled at a level lower than the picture level, such as a slice level, a tile level or the like. Compared with the conventional solution, where the activation of one or more NNPFs is controlled at the picture level, the proposed method can advantageously enable the application of NNPF in a refined manner, and thus the coding quality can be improved.

In some embodiments, a first set of syntax elements in the at least one set of syntax elements may comprise a plurality of syntax elements. In one example, the first set of syntax element may comprise a first syntax element indicating an NNPF specified by one or more neural-network post-filter characteristics (NNPFC) supplemental enhancement information (SEI) messages that pertain to the picture, and the first syntax element is represented by nnpfa_id. It should be understood that the first syntax element may also be represented by any other suitable string. The scope of the present disclosure is not limited in this respect.

In some embodiments, the at least one NNPF may be indicated by nnpfa_id[i], and i is an index of one of the at least one NNPF. Additionally or alternatively, a syntax element in the first set of syntax element may indicate the number of the at least one NNPF and the syntax element may be represented by nnpfa_num_minus1.

In some embodiments, information regarding whether to and/or how to signal the at least one set of syntax elements may be dependent on the number of the at least one NNPF. A neural-network post-filter activation (NNPFA) SEI message in the bitstream may comprise a second syntax element indicating the number of the at least one NNPF, and the second syntax element may be represented by nnpfa_num_minus1. It should be understood that the second syntax element may also be represented by any other suitable string. The scope of the present disclosure is not limited in this respect.

In some embodiments, a value of the second syntax element may be in the range from 0 to 255. In some embodiments, if a second syntax element indicating the number of the at least one NNPF is not comprised in the bitstream, a value of the second syntax element is inferred to be equal to a first value (such as 0 or the like).

In some embodiments, the second syntax element is dependent on a region type of the at least one NNPF. A used herein, the term region type may also be referred to as a video unit type. By way of example, the region type may be indicated by a third syntax element. By way of example rather than limitation, the third syntax element may be represented by nnpfa_region_type. In some embodiments, if a value of the third syntax element is equal to a second value (such as 0 or the like), the second syntax element is not comprised in the bitstream.

In some embodiments, a neural-network post-filter activation (NNPFA) SEI message in the bitstream may comprise a syntax element nnpfa_id[i] indicating an i-th NNPF in the at least one NNPF, and i is an integer. In some embodiments, the syntax element nnpfa_id[i] specifies that the i-th NNPF specified by one or more NNPFC SEI messages that pertain to the current picture and have a syntax element nnpfc_id equal to the syntax element nnfpa_id[i] is used for post-processing filtering for the current picture.

In some embodiments, an NNPFA SEI message in the bitstream may comprise a syntax element nnpfa_num_minus1 indicating the number of the at least one NNPF. Moreover, the number of identifications of the at least one NNPF is equal to the number of the at least one NNPF.

In some embodiments, a region type of the at least one NNPF may be indicated by a fourth syntax element. By way of example rather than limitation, the fourth syntax element may be represented by nnpfa_region_type.

In some embodiments, the fourth syntax element equal to a third value may indicate that an SEI message comprising the fourth syntax element activates one NNPF that is applied for the current picture. Additionally or alternatively, if the fourth syntax element is equal to the third value, a syntax element indicating the number of the at least one NNPF is not comprised in the bitstream.

Additionally or alternatively, the fourth syntax element greater than the third value may indicate that the SEI message activates one or more NNPFs. In one example, if the fourth syntax element is equal to a fourth value greater than the third value, no NNPF is applied for each slice of the current picture, or an NNPF applied for each slice of the current picture may be indicated. In another example, if the fourth syntax element is equal to a fifth value greater than the third value, no NNPF is applied for each coding tree unit (CTU) of the current picture, or an NNPF applied for each CTU of the current picture may be indicated. For example, the third value may be 0, the fourth value may be 1, and/or the fifth value may be 2. It should be understood that the specific value recited here is intended to be exemplary rather than limiting the scope of the present disclosure.

In some embodiments, a value of the fourth syntax element is in a first predetermined range, and values of the fourth syntax element greater than a sixth value are reserved and absent from the bitstream. In addition, an NNPFA SEI messages with the fourth syntax element greater than the sixth value is ignored. By way of example rather than limitation, the first predetermined range may be from 0 to 31, or the sixth value may be 2.

In some embodiments, the fourth syntax element is an unsigned integer 0-th order Exp-Golomb-coded syntax element with the left bit first. For example, the syntax element may be ue(v)-coded.

In some embodiments, a syntax element nnpfa_slice_enabling_flag[i] in an NNPFA SEI message in the bitstream may indicate a usage of NNPF at a slice level. For example, only one NNPF may be indicated by a syntax element nnpfa_ia in the NNPFA SEI message. Additionally or alternatively, a syntax element nnpfa_slice_index[i] in an NNPFA SEI message in the bitstream may indicate a usage of NNPF at a slice level. For example, one or more NNPFs are indicated by a syntax element nnpfa_ia[i] in the NNPFA SEI message.

In some embodiments, a syntax element nnpfa_ctu_enabling_flag[i] in an NNPFA SEI message in the bitstream may indicate a usage of NNPF at a coding tree unit (CTU) level. For example, only one NNPF may be indicated by a syntax element nnpfa_ia in the NNPFA SEI message. Additionally or alternatively, a syntax element nnpfa_ctu_index[i] in an NNPFA SEI message in the bitstream may indicate a usage of NNPF at a CTU level. For example, one or more NNPFs are indicated by a syntax element nnpfa_ia[i] in the NNPFA SEI message.

In some embodiments, if a third syntax element indicating a region type of the at least one NNPF is equal to a seventh value, at least one syntax element associate with a region type corresponding to the seventh value may be signaled. By way of example, the seventh value may be 1, and the at least one syntax element may comprise at least one of a syntax element nnpfa_slice_index[i] or a syntax element nnpfa_slice_enabling_flag[i]. Additionally or alternatively, the seventh value may be 2, and the at least one syntax element may comprise at least one of a syntax element nnpfa_ctu_index[i] or a syntax element nnpfa_ctu_enabling_flag[i].

In one example, nnpfa_slice_index[i] is signaled when nnpfa_region_type is equal to 1. In one example, nnpfa_slice_enabling_flag[i] is signaled when nnpfa_region_type is equal to 1. In one example, nnpfa_ctu_index[i] is signaled when nnpfa_region_type is equal to 2. In one example, nnpfa_ctu_enabling_flag[i] is signaled when nnpfa_region_type is equal to 2.

In some embodiments, at least one of a syntax element nnpfa_slice_enabling_flag[i] or a syntax element nnpfa_slice_index[i] equal to an eighth value may indicate that the at least one NNPF is not used in a current slice comprising the current video unit. Additionally or alternatively, at least one of a syntax element nnpfa_ctu_enabling_flag[i] or a syntax element nnpfa_ctu_index[i] equal to the eighth value may indicate that the at least one NNPF is not used in a current CTU comprising the current video unit. In some further embodiments, the syntax element nnpfa_slice_enabling_flag[i] equal to a ninth value may indicate that the at least one NNPF is used in the current slice. Additionally or alternatively, the syntax element nnpfa_ctu_enabling_flag[i] equal to the ninth value may indicate that the at least one NNPF is used in the current CTU. In some still further embodiments, the syntax element nnpfa_slice_index[i] greater than the eighth value may indicate that the at least one NNPF is used in the current slice. Additionally or alternatively, the syntax element nnpfa_ctu_index[i] greater than the eighth value may indicate that the at least one NNPF is used in the current CTU. By way of example rather than limitation, the eighth value may be 0 and/or the ninth value may be 1.

In some embodiments, a syntax element nnpfa_slice_index[i] greater than a tenth value may indicate that an NNPF with an index equal to a value of the syntax element nnpfa_slice_index[i] minus one is used in a current slice comprising the current video unit. Additionally or alternatively a syntax element nnpfa_ctu_index[i] greater than the tenth value may indicate that an NNPF with an index equal to a value of the syntax element nnpfa_ctu_index[i] minus one is used in a current CTU comprising the current video unit. For example, the tenth value may be 0. It should be understood that the specific value recited here is intended to be exemplary rather than limiting the scope of the present disclosure.

In some embodiments, a syntax element nnpfa_slice_enabling_flag[i] in an NNPFA SEI message in the bitstream may indicate a usage of NNPF at a slice level. By way of example, the syntax element nnpfa_slice_enabling_flag[i] equal to an eleventh value may indicate that NNPF is used for an i-th slice of the current picture. In addition, the syntax element nnpfa_slice_enabling_flag[i] equal to a twelfth value may indicate that NNPF is not used for the i-th slice of the current picture. For example, the eleventh value is 1 or the twelfth value may be 0. It should be understood that the specific value recited here is intended to be exemplary rather than limiting the scope of the present disclosure.

In some embodiments, a syntax element nnpfa_slice_index[i] in an NNPFA SEI message in the bitstream may indicate a usage of NNPF at a slice level. For example, the syntax element nnpfa_slice_index[i] equal to a thirteenth value may indicate that NNPF is not used for an i-th slice of the current picture. In addition, the syntax element nnpfa_slice_index[i] greater than the thirteenth value may indicate that NNPF with nnpfc_id equal to nnpfa_id [nnpfa_slice_index[i]−1] is used for the i-th slice of the current picture. By way of example rather than limitation, the thirteenth value may be 0.

In some embodiments, a value of the syntax element nnpfa_slice_index[i] may be in a second predetermined range. For example, the second predetermined range may be from 0 to the number of the at least one NNPF. It should be understood that the specific value recited here is intended to be exemplary rather than limiting the scope of the present disclosure.

In some embodiments, a syntax element nnpfa_ctu_enabling_flag[i] in an NNPFA SEI message in the bitstream may indicate a usage of NNPF at a CTU level. For example, the syntax element nnpfa_ctu_enabling_flag[i] equal to an fourteenth value may indicate that NNPF is used for an i-th CTU of the current picture. Additionally or alternatively, the syntax element nnpfa_ctu_enabling_flag[i] equal to a fifteenth value may indicate that NNPF is not used for the i-th CTU of the current picture. By way of example rather than limitation, the fourteenth value may be 1 and/or the fifteenth value may be 0.

In some embodiments, a syntax element nnpfa_ctu_index[i] in an NNPFA SEI message in the bitstream may indicate a usage of NNPF at a CTU level. For example, the syntax element nnpfa_ctu_index[i] equal to a sixteenth value may indicate that NNPF is not used for an i-th CTU of the current picture. Additionally or alternatively, the syntax element nnpfa_ctu_index[i] greater than the sixteenth value may indicate that NNPF with nnpfc_id equal to nnpfa_id [nnpfa_ctu_index[i]−1] is used for the i-th CTU of the current picture. By way of example, the sixteenth value may be 0.

In some embodiments, a value of the syntax element nnpfa_ctu_index[i] may be in a third predetermined range. By way of example rather than limitation, the third predetermined range may be from 0 to the number of the at least one NNPF.

It should be noted that the specific value recited above is intended to be exemplary rather than limiting the scope of the present disclosure. Moreover, the above mentioned syntax elements may also be represented by any other suitable string. The scope of the present disclosure is not limited in this respect.

In view of the above, in aid of the proposed syntax element, the proposed method can advantageously better support the application of NNPF at a level lower than the picture level, and thus the coding quality and coding efficiency can be improved.

According to further embodiments of the present disclosure, a non-transitory computer-readable recording medium is provided. The non-transitory computer-readable recording medium stores a bitstream of a video which is generated by a method performed by an apparatus for video processing. In the method, a conversion between a current video unit of the video and the bitstream is performed. The bitstream comprises at least one set of syntax elements for activating at least one neural-network post-filter (NNPF) for the current video unit. In addition, the current video unit is a portion of a current picture of the video.

According to still further embodiments of the present disclosure, a method for storing bitstream of a video is provided. In the method, a conversion between a current video unit of the video and the bitstream is performed. The bitstream comprises at least one set of syntax elements for activating at least one neural-network post-filter (NNPF) for the current video unit. In addition, the current video unit is a portion of a current picture of the video. Moreover, the bitstream is stored in a non-transitory computer-readable recording medium.

Implementations of the present disclosure can be described in view of the following clauses, the features of which can be combined in any reasonable manner.

Clause 1. A method for video processing, comprising: performing a conversion between a current video unit of a video and a bitstream of the video, wherein the bitstream comprises at least one set of syntax elements for activating at least one neural-network post-filter (NNPF) for the current video unit, and the current video unit is a portion of a current picture of the video.

Clause 2. The method of clause 1, wherein a first set of syntax elements in the at least one set of syntax elements comprises a plurality of syntax elements.

Clause 3. The method of clause 2, wherein the first set of syntax element comprises a first syntax element indicating an NNPF specified by one or more neural-network post-filter characteristics (NNPFC) supplemental enhancement information (SEI) messages that pertain to the picture, and the first syntax element is represented by nnpfa_id.

Clause 4. The method of clause 3, wherein the at least one NNPF is indicated by nnpfa_id[i], and i is an index of one of the at least one NNPF.

Clause 5. The method of any of clauses 2-4, wherein a syntax element in the first set of syntax element indicates the number of the at least one NNPF and is represented by nnpfa_num_minus1.

Clause 6. The method of any of clauses 1-5, wherein information regarding whether to and/or how to signal the at least one set of syntax elements is dependent on the number of the at least one NNPF, a neural-network post-filter activation (NNPFA) SEI message in the bitstream comprises a second syntax element indicating the number of the at least one NNPF, and the second syntax element is represented by nnpfa_num_minus1.

Clause 7. The method of clause 6, wherein a value of the second syntax element is in the range from 0 to 255.

Clause 8. The method of any of clauses 1-5, wherein if a second syntax element indicating the number of the at least one NNPF is not comprised in the bitstream, a value of the second syntax element is inferred to be equal to a first value.

Clause 9. The method of clause 8, wherein the first value is 0.

Clause 10. The method of any of clauses 1-8, wherein the second syntax element is dependent on a region type of the at least one NNPF.

Clause 11. The method of clause 10, wherein the region type is indicated by a third syntax element.

Clause 12. The method of clause 11, wherein the third syntax element is represented by nnpfa_region_type.

Clause 13. The method of any of clauses 11-12, wherein if a value of the third syntax element is equal to a second value, the second syntax element is not comprised in the bitstream.

Clause 14. The method of clause 13, wherein the second value is 0.

Clause 15. The method of any of clauses 1-14, wherein an NNPFA SEI message in the bitstream comprises a syntax element nnpfa_id[i] indicating an i-th NNPF in the at least one NNPF, and i is an integer.

Clause 16. The method of clause 15, wherein the syntax element nnpfa_id[i] specifies that the i-th NNPF specified by one or more NNPFC SEI messages that pertain to the current picture and have a syntax element nnpfc_id equal to the syntax element nnfpa_id[i] is used for post-processing filtering for the current picture.

Clause 17. The method of any of clauses 1-16, wherein an NNPFA SEI message in the bitstream comprises a syntax element nnpfa_num_minus1 indicating the number of the at least one NNPF.

Clause 18. The method of clause 17, wherein the number of identifications of the at least one NNPF is equal to the number of the at least one NNPF.

Clause 19. The method of any of clauses 1-18, wherein a region type of the at least one NNPF is indicated by a fourth syntax element.

Clause 20. The method of clause 19, wherein the fourth syntax element is represented by nnpfa_region_type.

Clause 21. The method of any of clauses 19-20, wherein the fourth syntax element equal to a third value indicates that an SEI message comprising the fourth syntax element activates one NNPF that is applied for the current picture.

Clause 22. The method of clause 21, wherein if the fourth syntax element is equal to the third value, a syntax element indicating the number of the at least one NNPF is not comprised in the bitstream.

Clause 23. The method of any of clauses 21-22, wherein the fourth syntax element greater than the third value indicates that the SEI message activates one or more NNPFs.

Clause 24. The method of clause 23, wherein if the fourth syntax element is equal to a fourth value greater than the third value, no NNPF is applied for each slice of the current picture, or an NNPF applied for each slice of the current picture is indicated, or if the fourth syntax element is equal to a fifth value greater than the third value, no NNPF is applied for each coding tree unit (CTU) of the current picture, or an NNPF applied for each CTU of the current picture is indicated.

Clause 25. The method of clause 24, wherein the third value is 0, the fourth value is 1, or the fifth value is 2.

Clause 26. The method of any of clauses 19-20, wherein a value of the fourth syntax element is in a first predetermined range, and values of the fourth syntax element greater than a sixth value are reserved and absent from the bitstream.

Clause 27. The method of clause 26, wherein an NNPFA SEI messages with the fourth syntax element greater than the sixth value is ignored.

Clause 28. The method of any of clauses 26-27, wherein the first predetermined range is from 0 to 31, or the sixth value is 2.

Clause 29. The method of any of clauses 19-28, wherein the fourth syntax element is an unsigned integer 0-th order Exp-Golomb-coded syntax element with the left bit first.

Clause 30. The method of any of clauses 1-29, wherein a syntax element nnpfa_slice_enabling_flag[i] in an NNPFA SEI message in the bitstream indicates a usage of NNPF at a slice level.

Clause 31. The method of clause 30, wherein only one NNPF is indicated by a syntax element nnpfa_ia in the NNPFA SEI message.

Clause 32. The method of any of clauses 1-29, wherein a syntax element nnpfa_slice_index[i] in an NNPFA SEI message in the bitstream indicates a usage of NNPF at a slice level.

Clause 33. The method of clause 32, wherein one or more NNPFs are indicated by a syntax element nnpfa_ia[i] in the NNPFA SEI message.

Clause 34. The method of any of clauses 1-33, wherein a syntax element nnpfa_ctu_enabling_flag[i] in an NNPFA SEI message in the bitstream indicates a usage of NNPF at a coding tree unit (CTU) level.

Clause 35. The method of clause 34, wherein only one NNPF is indicated by a syntax element nnpfa_ia in the NNPFA SEI message.

Clause 36. The method of any of clauses 1-33, wherein a syntax element nnpfa_ctu_index[i] in an NNPFA SEI message in the bitstream indicates a usage of NNPF at a CTU level.

Clause 37. The method of clause 36, wherein one or more NNPFs are indicated by a syntax element nnpfa_ia[i] in the NNPFA SEI message.

Clause 38. The method of any of clauses 1-27, wherein if a third syntax element indicating a region type of the at least one NNPF is equal to a seventh value, at least one syntax element associate with a region type corresponding to the seventh value is signaled.

Clause 39. The method of clause 38, wherein the seventh value is 1, and the at least one syntax element comprises at least one of a syntax element nnpfa_slice_index[i] or a syntax element nnpfa_slice_enabling_flag[i].

Clause 40. The method of clause 38, wherein the seventh value is 2, and the at least one syntax element comprises at least one of a syntax element nnpfa_ctu_index[i] or a syntax element nnpfa_ctu_enabling_flag[i].

Clause 41. The method of any of clauses 1-40, wherein at least one of a syntax element nnpfa_slice_enabling_flag[i] or a syntax element nnpfa_slice_index[i] equal to an eighth value indicates that the at least one NNPF is not used in a current slice comprising the current video unit, or at least one of a syntax element nnpfa_ctu_enabling_flag[i] or a syntax element nnpfa_ctu_index[i] equal to the eighth value indicates that the at least one NNPF is not used in a current CTU comprising the current video unit, or the syntax element nnpfa_slice_enabling_flag[i] equal to a ninth value indicates that the at least one NNPF is used in the current slice, or the syntax element nnpfa_ctu_enabling_flag[i] equal to the ninth value indicates that the at least one NNPF is used in the current CTU, or the syntax element nnpfa_slice_index[i] greater than the eighth value indicates that the at least one NNPF is used in the current slice, or the syntax element nnpfa_ctu_index[i] greater than the eighth value indicates that the at least one NNPF is used in the current CTU.

Clause 42. The method of clause 41, wherein the eighth value is 0 or the ninth value is 1.

Clause 43. The method of any of clauses 1-42, wherein a syntax element nnpfa_slice_index[i] greater than a tenth value indicates that an NNPF with an index equal to a value of the syntax element nnpfa_slice_index[i] minus one is used in a current slice comprising the current video unit, or a syntax element nnpfa_ctu_index[i] greater than the tenth value indicates that an NNPF with an index equal to a value of the syntax element nnpfa_ctu_index[i] minus one is used in a current CTU comprising the current video unit.

Clause 44. The method of clause 43, wherein the tenth value is 0.

Clause 45. The method of any of clauses 1-44, wherein a syntax element nnpfa_slice_enabling_flag[i] in an NNPFA SEI message in the bitstream indicates a usage of NNPF at a slice level.

Clause 46. The method of clause 45, wherein the syntax element nnpfa_slice_enabling_flag[i] equal to an eleventh value indicates that NNPF is used for an i-th slice of the current picture, or the syntax element nnpfa_slice_enabling_flag[i] equal to a twelfth value indicates that NNPF is not used for the i-th slice of the current picture.

Clause 47. The method of clause 46, wherein the eleventh value is 1 or the twelfth value is 0.

Clause 48. The method of any of clauses 1-47, wherein a syntax element nnpfa_slice_index[i] in an NNPFA SEI message in the bitstream indicates a usage of NNPF at a slice level.

Clause 49. The method of clause 48, wherein the syntax element nnpfa_slice_index[i] equal to a thirteenth value indicates that NNPF is not used for an i-th slice of the current picture, or the syntax element nnpfa_slice_index[i] greater than the thirteenth value indicates that NNPF with nnpfc_id equal to nnpfa_id [nnpfa_slice_index[i]−1] is used for the i-th slice of the current picture.

Clause 50. The method of clause 49, wherein the thirteenth value is 0.

Clause 51. The method of any of clauses 49-50, wherein a value of the syntax element nnpfa_slice_index[i] is in a second predetermined range.

Clause 52. The method of clause 51, wherein the second predetermined range is from 0 to the number of the at least one NNPF.

Clause 53. The method of any of clauses 1-52, wherein a syntax element nnpfa_ctu_enabling_flag[i] in an NNPFA SEI message in the bitstream indicates a usage of NNPF at a CTU level.

Clause 54. The method of clause 53, wherein the syntax element nnpfa_ctu_enabling_flag[i] equal to an fourteenth value indicates that NNPF is used for an i-th CTU of the current picture, or the syntax element nnpfa_ctu_enabling_flag[i] equal to a fifteenth value indicates that NNPF is not used for the i-th CTU of the current picture.

Clause 55. The method of clause 54, wherein the fourteenth value is 1 or the fifteenth value is 0.

Clause 56. The method of any of clauses 1-55, wherein a syntax element nnpfa_ctu_index[i] in an NNPFA SEI message in the bitstream indicates a usage of NNPF at a CTU level.

Clause 57. The method of clause 56, wherein the syntax element nnpfa_ctu_index[i] equal to a sixteenth value indicates that NNPF is not used for an i-th CTU of the current picture, or the syntax element nnpfa_ctu_index[i] greater than the sixteenth value indicates that NNPF with nnpfc_id equal to nnpfa_id [nnpfa_ctu_index[i]−1] is used for the i-th CTU of the current picture.

Clause 58. The method of clause 57, wherein the sixteenth value is 0.

Clause 59. The method of any of clauses 57-58, wherein a value of the syntax element nnpfa_ctu_index[i] is in a third predetermined range.

Clause 60. The method of clause 59, wherein the third predetermined range is from 0 to the number of the at least one NNPF.

Clause 61. The method of any of clauses 1-60, wherein the conversion includes encoding the current video unit into the bitstream.

Clause 62. The method of any of clauses 1-60, wherein the conversion includes decoding the current video unit from the bitstream.

Clause 63. An apparatus for video processing comprising a processor and a non-transitory memory with instructions thereon, wherein the instructions upon execution by the processor, cause the processor to perform a method in accordance with any of clauses 1-62.

Clause 64. A non-transitory computer-readable storage medium storing instructions that cause a processor to perform a method in accordance with any of clauses 1-62.

Clause 65. A non-transitory computer-readable recording medium storing a bitstream of a video which is generated by a method performed by an apparatus for video processing, wherein the method comprises: performing a conversion between a current video unit of the video and the bitstream, wherein the bitstream comprises at least one set of syntax elements for activating at least one neural-network post-filter (NNPF) for the current video unit, and the current video unit is a portion of a current picture of the video.

Clause 66. A method for storing a bitstream of a video, comprising: performing a conversion between a current video unit of the video and the bitstream, wherein the bitstream comprises at least one set of syntax elements for activating at least one neural-network post-filter (NNPF) for the current video unit, and the current video unit is a portion of a current picture of the video; and storing the bitstream in a non-transitory computer-readable recording medium.

### Example Device

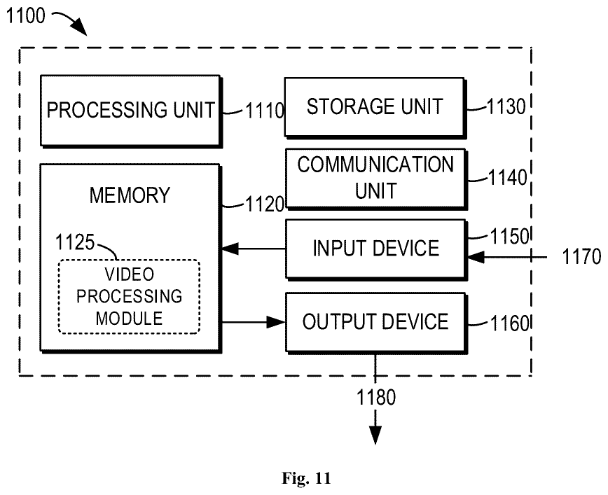

FIG. 11 illustrates a block diagram of a computing device 1100 in which various embodiments of the present disclosure can be implemented. The computing device 1100 may be implemented as or included in the source device 110 (or the video encoder 114 or 200) or the destination device 120 (or the video decoder 124 or 300).

It would be appreciated that the computing device 1100 shown in FIG. 11 is merely for purpose of illustration, without suggesting any limitation to the functions and scopes of the embodiments of the present disclosure in any manner.

As shown in FIG. 11, the computing device 1100 includes a general-purpose computing device 1100. The computing device 1100 may at least comprise one or more processors or processing units 1110, a memory 1120, a storage unit 1130, one or more communication units 1140, one or more input devices 1150, and one or more output devices 1160.

In some embodiments, the computing device 1100 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1100 can support any type of interface to a user (such as “wearable” circuitry and the like).

The processing unit 1110 may be a physical or virtual processor and can implement various processes based on programs stored in the memory 1120. In a multi-processor system, multiple processing units execute computer executable instructions in parallel so as to improve the parallel processing capability of the computing device 1100. The processing unit 1110 may also be referred to as a central processing unit (CPU), a microprocessor, a controller or a microcontroller.

The computing device 1100 typically includes various computer storage medium. Such medium can be any medium accessible by the computing device 1100, including, but not limited to, volatile and non-volatile medium, or detachable and non-detachable medium. The memory 1120 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1130 may be any detachable or non-detachable medium and may include a machine-readable medium such as a memory, flash memory drive, magnetic disk or another other media, which can be used for storing information and/or data and can be accessed in the computing device 1100.

The computing device 1100 may further include additional detachable/non-detachable, volatile/non-volatile memory medium. Although not shown in FIG. 11, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1140 communicates with a further computing device via the communication medium. In addition, the functions of the components in the computing device 1100 can be implemented by a single computing cluster or multiple computing machines that can communicate via communication connections. Therefore, the computing device 1100 can operate in a networked environment using a logical connection with one or more other servers, networked personal computers (PCs) or further general network nodes.

The input device 1150 may be one or more of a variety of input devices, such as a mouse, keyboard, tracking ball, voice-input device, and the like. The output device 1160 may be one or more of a variety of output devices, such as a display, loudspeaker, printer, and the like. By means of the communication unit 1140, the computing device 1100 can further communicate with one or more external devices (not shown) such as the storage devices and display device, with one or more devices enabling the user to interact with the computing device 1100, or any devices (such as a network card, a modem and the like) enabling the computing device 1100 to communicate with one or more other computing devices, if required. Such communication can be performed via input/output (I/O) interfaces (not shown).

In some embodiments, instead of being integrated in a single device, some or all components of the computing device 1100 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1100 may be used to implement video encoding/decoding in embodiments of the present disclosure. The memory 1120 may include one or more video coding modules 1125 having one or more program instructions. These modules are accessible and executable by the processing unit 1110 to perform the functionalities of the various embodiments described herein.

In the example embodiments of performing video encoding, the input device 1150 may receive video data as an input 1170 to be encoded. The video data may be processed, for example, by the video coding module 1125, to generate an encoded bitstream. The encoded bitstream may be provided via the output device 1160 as an output 1180.

In the example embodiments of performing video decoding, the input device 1150 may receive an encoded bitstream as the input 1170. The encoded bitstream may be processed, for example, by the video coding module 1125, to generate decoded video data. The decoded video data may be provided via the output device 1160 as the output 1180.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
performing a conversion between a current video unit of a video and a bitstream of the video, wherein the bitstream comprises at least one set of syntax elements for activating at least one neural-network post-filter (NNPF) for the current video unit, and the current video unit is a portion of a current picture of the video.

2. The method of claim 1, wherein a first set of syntax elements in the at least one set of syntax elements comprises a plurality of syntax elements.

3. The method of claim 2, wherein the first set of syntax element comprises a first syntax element indicating an NNPF specified by one or more neural-network post-filter characteristics (NNPFC) supplemental enhancement information (SEI) messages that pertain to the picture, and the first syntax element is represented by nnpfa_id, or wherein a syntax element in the first set of syntax element indicates the number of the at least one NNPF and is represented by nnpfa_num_minus1.

4. The method of claim 1, wherein information regarding whether to and/or how to signal the at least one set of syntax elements is dependent on the number of the at least one NNPF, a neural-network post-filter activation (NNPFA) SEI message in the bitstream comprises a second syntax element indicating the number of the at least one NNPF, and the second syntax element is represented by nnpfa_num_minus1, or
wherein if a second syntax element indicating the number of the at least one NNPF is not comprised in the bitstream, a value of the second syntax element is inferred to be equal to a first value, or
wherein the second syntax element is dependent on a region type of the at least one NNPF.

5. The method of claim 1, wherein an NNPFA SEI message in the bitstream comprises a syntax element nnpfa_id[i] indicating an i-th NNPF in the at least one NNPF, and i is an integer, or
wherein an NNPFA SEI message in the bitstream comprises a syntax element nnpfa_num_minus1 indicating the number of the at least one NNPF.

6. The method of claim 1, wherein a region type of the at least one NNPF is indicated by a fourth syntax element.

7. The method of claim 6, wherein the fourth syntax element is represented by nnpfa_region_type, or
wherein the fourth syntax element equal to a third value indicates that an SEI message comprising the fourth syntax element activates one NNPF that is applied for the current picture, or
wherein if the fourth syntax element is equal to the third value, a syntax element indicating the number of the at least one NNPF is not comprised in the bitstream, or
wherein the fourth syntax element greater than the third value indicates that the SEI message activates one or more NNPFs, or
wherein if the fourth syntax element is equal to a fourth value greater than the third value, no NNPF is applied for each slice of the current picture, or an NNPF applied for each slice of the current picture is indicated, or if the fourth syntax element is equal to a fifth value greater than the third value, no NNPF is applied for each coding tree unit (CTU) of the current picture, or an NNPF applied for each CTU of the current picture is indicated, or
wherein a value of the fourth syntax element is in a first predetermined range, and values of the fourth syntax element greater than a sixth value are reserved and absent from the bitstream, or
wherein the fourth syntax element is an unsigned integer 0-th order Exp-Golomb-coded syntax element with the left bit first.

8. The method of claim 1, wherein a syntax element nnpfa_slice_enabling_flag[i] in an NNPFA SEI message in the bitstream indicates a usage of NNPF at a slice level, or
wherein a syntax element nnpfa_slice_index[i] in an NNPFA SEI message in the bitstream indicates a usage of NNPF at a slice level, or
wherein a syntax element nnpfa_ctu_enabling_flag[i] in an NNPFA SEI message in the bitstream indicates a usage of NNPF at a coding tree unit (CTU) level, or
wherein a syntax element nnpfa_ctu_index[i] in an NNPFA SEI message in the bitstream indicates a usage of NNPF at a CTU level, or
wherein if a third syntax element indicating a region type of the at least one NNPF is equal to a seventh value, at least one syntax element associate with a region type corresponding to the seventh value is signaled.

9. The method of claim 1, wherein at least one of a syntax element nnpfa_slice_enabling_flag[i] or a syntax element nnpfa_slice_index[i] equal to an eighth value indicates that the at least one NNPF is not used in a current slice comprising the current video unit, or
at least one of a syntax element nnpfa_ctu_enabling_flag[i] or a syntax element nnpfa_ctu_index[i] equal to the eighth value indicates that the at least one NNPF is not used in a current CTU comprising the current video unit, or
the syntax element nnpfa_slice_enabling_flag[i] equal to a ninth value indicates that the at least one NNPF is used in the current slice, or
the syntax element nnpfa_ctu_enabling_flag[i] equal to the ninth value indicates that the at least one NNPF is used in the current CTU, or
the syntax element nnpfa_slice_index[i] greater than the eighth value indicates that the at least one NNPF is used in the current slice, or
the syntax element nnpfa_ctu_index[i] greater than the eighth value indicates that the at least one NNPF is used in the current CTU.

10. The method of claim 1, wherein a syntax element nnpfa_slice_index[i] greater than a tenth value indicates that an NNPF with an index equal to a value of the syntax element nnpfa_slice_index[i] minus one is used in a current slice comprising the current video unit, or
a syntax element nnpfa_ctu_index[i] greater than the tenth value indicates that an NNPF with an index equal to a value of the syntax element nnpfa_ctu_index[i] minus one is used in a current CTU comprising the current video unit.

11. The method of claim 1, wherein a syntax element nnpfa_slice_enabling_flag[i] in an NNPFA SEI message in the bitstream indicates a usage of NNPF at a slice level.

12. The method of claim 11, wherein the syntax element nnpfa_slice_enabling_flag[i] equal to an eleventh value indicates that NNPF is used for an i-th slice of the current picture, or the syntax element nnpfa_slice_enabling_flag[i] equal to a twelfth value indicates that NNPF is not used for the i-th slice of the current picture, or
wherein the eleventh value is 1 or the twelfth value is 0.

13. The method of claim 1, wherein a syntax element nnpfa_slice_index[i] in an NNPFA SEI message in the bitstream indicates a usage of NNPF at a slice level.

14. The method of claim 13, wherein the syntax element nnpfa_slice_index[i] equal to a thirteenth value indicates that NNPF is not used for an i-th slice of the current picture, or the syntax element nnpfa_slice_index[i] greater than the thirteenth value indicates that NNPF with nnpfc_id equal to nnpfa_id [nnpfa_slice_index[i]−1] is used for the i-th slice of the current picture, or
wherein the thirteenth value is 0, or
wherein a value of the syntax element nnpfa_slice_index[i] is in a second predetermined range, or
the second predetermined range is from 0 to the number of the at least one NNPF.

15. The method of claim 1, wherein a syntax element nnpfa_ctu_enabling_flag[i] in an NNPFA SEI message in the bitstream indicates a usage of NNPF at a CTU level, or
wherein a syntax element nnpfa_ctu_index[i] in an NNPFA SEI message in the bitstream indicates a usage of NNPF at a CTU level.

16. The method of claim 1, wherein the conversion includes encoding the current video unit into the bitstream.

17. The method of claim 1, wherein the conversion includes decoding the current video unit from the bitstream.

18. An apparatus for video processing comprising a processor and a non-transitory memory with instructions thereon, wherein the instructions upon execution by the processor, cause the processor to perform acts comprising:
performing a conversion between a current video unit of a video and a bitstream of the video, wherein the bitstream comprises at least one set of syntax elements for activating at least one neural-network post-filter (NNPF) for the current video unit, and the current video unit is a portion of a current picture of the video.

19. A non-transitory computer-readable storage medium storing instructions that cause a processor to perform acts comprising:
performing a conversion between a current video unit of a video and a bitstream of the video, wherein the bitstream comprises at least one set of syntax elements for activating at least one neural-network post-filter (NNPF) for the current video unit, and the current video unit is a portion of a current picture of the video.

20. A non-transitory computer-readable recording medium storing a bitstream of a video which is generated by a method performed by an apparatus for video processing, wherein the method comprises:
performing a conversion between a current video unit of the video and the bitstream, wherein the bitstream comprises at least one set of syntax elements for activating at least one neural-network post-filter (NNPF) for the current video unit, and the current video unit is a portion of a current picture of the video.
